(19) United States
(12) Patent Application Publication
(10) Pub. No.: US 2023/0352698 A1
(43) Pub. Date: Nov. 2, 2023

(54) Method for Producing Coating Composition, Yttria-Stabilized Zirconia Layer, Electrochemical Element, Electrochemical Module, Electrochemical Device, Energy System, Solid Oxide Fuel Cell, and Solid Oxide Electrolysis Cell

(71) Applicant: Osaka Gas Co., Ltd., Osaka-shi (JP)

(72) Inventors: Hiroaki Matsuyoshi, Osaka-shi (JP); Mitsuaki Echigo, Osaka-shi (JP); Kyohei Manabe, Osaka-shi (JP)

(21) Appl. No.: 17/914,222

(22) PCT Filed: Mar. 31, 2021
(86) PCT No.: PCT/JP2021/014085

§ 371 Date: Sep. 23, 2022

(30) Foreign Application Priority Data
Mar. 31, 2020 (JP) 2020-064483

(51) Int. Cl. H01M 4/90; H01M 8/04014; H01M 8/0656

(52) U.S. Cl. CPC H01M 4/9025; H01M 8/04022; H01M 8/0656

(57) ABSTRACT

-- A coating composition enables film formation at low cost with a simple method by using a zirconium alkoxide and an yttrium compound as starting raw materials, and enables a dense yttria-stabilized zirconia layer to be obtained, The coating composition containing the zirconium alkoxide, the yttrium compound, a chelate compound, a catalyst, water, and an organic solvent is obtained. The coating composition may also contain yttria-stabilized zirconia fine particles

### CROSS-REFERENCE TO RELATED APPLICATIONS

This application is the U.S. national phase of International Application No. PCT/JP2021/014085 filed Mar. 31, 2021, and claims priority to Japanese Patent Application No. 2020-064483 filed Mar. 31, 2020, the disclosures of which are hereby incorporated by reference in their entirety.

### BACKGROUND OF THE INVENTION

### Field of the Invention

The present invention relates to a method for producing a coating composition that can be applied on surfaces of various members to form an yttria-stabilized zirconia layer, and also relates to various functional members including an yttria-stabilized zirconia layer.

### Description of Related Art

It has been known in the related art that surfaces of various members are coated with yttria-stabilized zirconia (hereinafter, may be referred to as YSZ), and the surface-coated various members are used for parts required to have a high degree of hardness and inertness and refractory parts that are used for jet engines and the like. Furthermore, a solid electrolyte for a solid oxide fuel cell (SOFC) used at a relatively high temperature has been also known. The following techniques are available as applications of solid electrolytes for SOFC.

In JP-A-H7-235317, a coating solution obtained by dissolving zirconium alkoxide and yttrium nitrate hydrate in a first solvent that is a common solvent, and dissolving the result solution in a second solvent for homogenization is disclosed.

Here, as the first solvent, it is described in [0025] that 2-propanol and 2-methyl-1-propanol are also suitable in addition to 1-propanol, and benzene, hexane, methanol, ethanol, and the like can be used.

On the other hand, it is described in [0024] that the second solvent is described as a solvent for homogenization, and specifically, triethanolamine or diethanolamine can be used in addition to 2,4-pentanedione.

### Citation List

### Patent Literature

However, it has been found that the technique disclosed in JP-A-H7-235317 has the following problems.

In a case where the yttria-stabilized zirconia is to be formed on a surface of an air electrode molded body composed of a porous body of a metal oxide, as an electrolyte layer, this molded body is immersed in a coating solution, and dipping operation is repeated, thereby obtaining the yttria-stabilized zirconia coating. Therefore, in order to obtain the yttria-stabilized zirconia film having a film thickness of about 1 µm, it is required to repeat the dipping operation 20 times, which causes deterioration in terms of productivity.

(2) In the production of the coating solution composition, it is required to carry out two steps of dissolution with the first solvent and homogeneous dissolution with the second solvent, which complicates the production process.

(3) Comparative Examples will be described later by comparison with Examples, but this method causes the entire surface of a coating film to be scabrous and to have rough appearance, and causes the coating film to be easily peeled off by a simple touch with a finger, so that the coating film is not maintained until calcination required after the coating film is formed.

On the other hand, in a case where a coating film is typically formed by a sol-gel reaction in which a zirconium alkoxide or an yttrium compound is used as a starting raw material, a hydrolysis rate of the zirconium alkoxide is extremely faster than that of a common silicon alkoxide. Therefore, in a case where the coating film is to have a film thickness of 1 µm or greater, defects such as cracks are likely to occur on a surface.

### SUMMARY OF THE INVENTION

The present invention has been made in view of the above-mentioned problems, and a subjective of the present invention is to provide a coating composition that enables film formation at low cost with a simple method by using a zirconium alkoxide and an yttrium compound as starting raw materials, and that enables a dense yttria-stabilized zirconia layer to be obtained.

A first feature configuration of the present invention is to produce a coating composition obtained by mixing a zirconium alkoxide, an yttrium compound, a chelate compound, a catalyst, water, and an organic solvent.

The coating composition produced by this method contains water necessary for hydrolysis of the zirconium alkoxide, and further contains a catalyst for inducing the hydrolysis and a condensation reaction thereof; thereby the coating composition can be formed to have a desired coating film thickness with a simple method of applying the coating composition, for example, by using an air spray or the like. According to the studies carried out by the inventors, the yttria-stabilized zirconia layer having few defects can be easily obtained by using the coating composition of the present invention.

A second feature configuration of the present invention is that the coating composition includes yttria-stabilized zirconia fine particles.

This configuration is adopted to enable that the yttria-stabilized zirconia fine particles serve as a filler (aggregate) to easily ensure a layer thickness (film thickness) thereof in a case of forming the yttria-stabilized zirconia layer. As will be described later, the layer thickness obtained by using the coating composition that contains the yttria-stabilized zirconia fine particles and carrying out coating operation repeated predetermined times can be made thicker than a layer thickness obtained by using a coating composition that does not contain the yttria-stabilized zirconia fine particles and carrying out coating operation repeated the same times (see comparison of Example 1 and Example 10 described later, and comparison of Example 2 and Example 11). As a result of adding the yttria-stabilized zirconia fine particles, reduction of stress in the yttria-stabilized zirconia layer can contribute to defects such as cracks to be prevented.

A third feature configuration of the present invention is that a content of the yttria-stabilized zirconia fine particles is 1% to 10% by mass with respect to the zirconium alkoxide.

That is, as a resulting of setting an amount ratio (mass ratio) of the yttria-stabilized zirconia fine particles to the zirconium alkoxide to 1% to 10% by mass, the contained fine particles can serve as a filler. Here, in a case of smaller than 1% by mass, it may be difficult to obtain the effect of adding the fine particles. By contrast, in a case of greater than 10% by mass, the action of the raw material that contributes to the original layer formation may be disturbed, and the uniformity and dispersibility in the coating composition may be deteriorated.

A fourth feature configuration of the present invention is that an average particle size of the yttria-stabilized zirconia fine particles is 0.1 to 2 µm.

The average particle size of the yttria-stabilized zirconia fine particles is preferably 0.1 to 2 µm. Here, in a case where the average particle size is smaller than 0.1 µm, the fine particles may aggregate in the coating composition and impair the dispersibility and uniformity, and in a case where the average particle size is greater than 2 µm, there are concerns about problems of the smoothness of the coating film and uneven distribution of the fine particles in the coating film.

A fifth feature configuration of the present invention is that in the coating composition, a content of the zirconium alkoxide is 10% to 30% by mass, a content of the yttrium compound is 1% to 10% by mass, a content of the chelate compound is 5% to 20% by mass, a content of the catalyst is 0.1% to 2% by mass, a content of the water is 0.1% to 2% by mass, and a content of the organic solvent is a remainder.

In a case where the content of the zirconium alkoxide is less than 10% by mass, the raw material tends to be in short supply, so that the production of a target product is delayed. By contrast, in a case where the content of the zirconium alkoxide is more than 30% by mass, hydrolysis and condensation may proceed too quickly.

In a case where the content of the yttrium compound is less than 1% by mass, the raw material tends to be in short supply, so that it is difficult to obtain a target product. By contrast, the content of the yttrium compound is more than 10% by mass, the amount of yttrium in the produced film may be excessive.

In a case where the content of the chelate compound is less than 5% by mass, it is difficult to obtain the effect of suppressing the hydrolysis rate and polycondensation rate of the zirconium alkoxide. By contrast, in a case where the content of the chelate compound is more than 20% by mass, the hydrolysis rate and the polycondensation rate are likely to be excessively suppressed.

The catalyst is used as a deflocculant that uniformly initiates the dissolution and hydrolysis of the zirconium alkoxide and at the same time uniformly disperses a sol produced by the hydrolysis.

In a case where the content of the catalyst is less than 0.1% by mass, the catalyst may not be fully act. Even though the content of the catalyst of more than 2% by mass is added, no further effect can be obtained.

Water is used to dissolve and hydrolyze zirconium alkoxide. The amount of water added is preferably about 0.25 to 1.0 mol with respect to 1 mol of zirconium alkoxide. The content of water in the coating composition is preferably 0.1% to 2% by mass.

Since water is also used for dissolving and hydrolyzing zirconium alkoxide, it is difficult to achieve the purpose of promoting a hydrolysis reaction unique to the composition in a case of less than 0.25 mol. Even though the content of the water of more than 1.0 mol is added, no further effect can be obtained. From the viewpoint of coatability and ease of handling of the coating composition, the content of the water is preferably within a range of about 0.1% to 2% by mass.

The organic solvent is used to dissolve a zirconium alkoxide, an yttrium compound, a chelate compound, a catalyst, and water.

Since an alkoxy group of the zirconium alkoxide is hydrophobic and does not mix with water, an alcohol for mixing both an alkoxide and water with each other is necessary.

In a case where the organic solvent contains the yttria-stabilized zirconia fine particles, a content of the yttria-stabilized zirconia fine particles in the coating composition is preferably within a range of about 0.1% to 1% by mass.

As described in a sixth feature configuration of the present invention, examples of the zirconium alkoxide, a starting raw material of yttria-stabilized zirconia, includes zirconium (IV) methoxide, zirconium (IV) ethoxide, zirconium (IV) n-propoxide, zirconium (IV) i-propoxide, zirconium (IV) n-butoxide, zirconium (IV) i-butoxide, zirconium (IV) sec-butoxide, or zirconium (IV) t-butoxide.

Among these, zirconium (IV) n-propoxide, zirconium (IV) i-propoxide, and zirconium (IV) n-butoxide are preferable from the viewpoint of easy availability and hydrolyzability. As a result of combining these compounds with a chelate compound described later, an yttria-stabilized zirconia layer without cracking or peeling can be obtained.

As described in a seventh feature configuration of the present invention, examples of the yttrium compound, a starting raw material of yttria-stabilized zirconia, includes yttrium nitrate, yttrium chloride, yttrium sulfate, yttrium phosphate, yttrium acetate, yttrium carbonate, yttrium (III) ethoxide, yttrium (III) n-propoxide, or yttrium (III) i-propoxide.

In a case where an inorganic acid salt is used for the yttrium compound, it is preferable to use the same type of inorganic acid as the catalyst described later. For example, in a case where yttrium nitrate is used, it is preferable to use nitric acid. The same applies to an organic acid salt.

Among these, yttrium nitrate, yttrium chloride, yttrium sulfate, yttrium phosphate, yttrium carbonate, yttrium acetate, yttrium (III) i-propoxide are preferable from the viewpoint of availability and reactivity. As a result of using these compounds, the yttria-stabilized zirconia layer can be formed by a reaction with a hydrolysis product of the zirconium alkoxide.

As described in an eighth feature configuration of the present invention, the chelate compound is represented by General Formula (1),

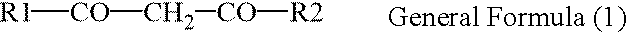

[in Formula, R1 and R2 are alkyl groups having 1 to 6 carbon atoms (including a fluorinated alkyl group) or monocyclic or bicyclic aryl groups; R1 and R2 are the same or different from each other, and each are an alkyl group having 1 to 6 carbon atoms or a monocyclic or bicyclic aryl group, and R1 and R2 may be bonded to each other to form a cyclic alkyl group].

This chelate compound coordinates with the zirconium alkoxide to suppress the hydrolysis rate and polycondensation rate of the zirconium alkoxide.

As described in a ninth feature configuration of the present invention, examples of this kind of the chelate compound includes 2,4-pentanedione, 2,4-hexanedione, 3,5-heptanedione, 2,6-dimethyl-3,5-heptanedione, 2,2,6,6-tetramethyl-3,5-heptanedione, 1-phenyl-1,3-butanedione, 1,3-diphenyl-1,3-propanedione, 1,1,1-trifluoro-2,4-pentanedione, 1,1,1,5,5,5-hexafluoro-2,4-pentanedione, and 1,3-cyclohexanedione.

Among these, 2,4-pentanedione, 3,5-heptanedione, 2,6-dimethyl-3,5-heptanedione, 2,2,6,6-tetramethyl-3,5-heptanedione, 1-phenyl-1,3-butanedione, 1,3-diphenyl-1,3-propanedione are preferable from the viewpoint of availability and coordination force to zirconium alkoxide. Since R1 and R2 are electron donating groups of a methyl group, an ethyl group, a propyl group, a butyl group, and a phenyl group, these compounds have excellent coordination force to the zirconium alkoxide, and enables the hydrolysis reaction rate and polycondensation reaction rate of the zirconium alkoxide to be suppressed; thereby the yttria-stabilized zirconia layer without cracking and peeling can be obtained.

As described in a tenth feature configuration of the present invention, hydrochloric acid, nitric acid, sulfuric acid, phosphoric acid, carbonic acid, and acetic acid can be used as the catalyst.

Among these, nitric acid, hydrochloric acid, sulfuric acid, phosphoric acid, and acetic acid are preferable from the viewpoint of hydrolyzability and deflocculant of the zirconium alkoxide. As a result of using these acids, since the zirconium alkoxide can be hydrolyzed uniformly and the resulting sol can be uniformly dispersed in the reaction solution, an yttria-stabilized zirconia layer without cracking or peeling can be obtained.

As described in an eleventh feature configuration of the present invention, examples of the organic solvent include methanol, ethanol, 1-propanol, 2-propanol, 1-butanol, 2-methyl-1-propanol, 2-butanol, and 2-methyl-2-propanol. The content of the remainder of other components (zirconium alkoxide, yttrium compound, chelate compound, catalyst, and water) in the coating composition is preferably 40% to 80% by mass in a state in which the conditions of the other components are satisfied.

Here, in a case where the content of the organic solvent is less than 40% by mass, sufficient mixing performance may not be obtained. In a case where the content of the organic solvent is added in an amount of more than 80% by mass, raw material components tend to be insufficient.

As the alcohol, for example, an alcohol corresponding to the alkoxide of the zirconium alkoxide used may be used, but the alcohol is not particularly limited as long as the zirconium alkoxide and the yttrium compound can be dissolved.

As described in a twelfth feature configuration of the present invention, in a case where an alcohol having a smaller number of carbon atoms than the alcohol corresponding to the alkoxide of the zirconium alkoxide is used as the solvent, the film thickness of the yttria-stabilized zirconia coating film can be increased (see comparison between Examples 1 and 5, comparison between Example 6 and Example 7, comparison between Example 6 and Example 8, and comparison between Example 6 and Example 9, which will be described later). This is because a part of the alkoxide of the zirconium alkoxide is substituted with the alkoxide having a small carbon number in a case where an alcohol having a smaller number of carbon atoms than the alkoxide of the zirconium alkoxide is used as a solvent. It is considered that since interaction between the unsubstituted alkoxide and the alcohol having a small carbon number used in the solvent is reduced, resulting in easier water attack on the unsubstituted alkoxide, the hydrolysis and polycondensation reaction rates of zirconium alkoxide can be increased to improve the film thickness.

### Usage Form of Yttria-Stabilized Zirconia Layer

Hereinafter, a case where the yttria-stabilized zirconia layer according to the present invention is adopted for the “electrochemical element” in the present invention will be described.

Regarding the “electrochemical element” in the present invention, the electrochemical element is configured to include a counter electrode layer on a side opposite to an electrode layer with an electrolyte layer interposed therebetween.

Here, in a case where this electrochemical element serves as a fuel cell, for example, the electrode layer can serve as a fuel electrode layer, and the counter electrode layer can serve as an air electrode layer to obtain power generated electric power between both electrodes. That is, a reduction gas (typically a fuel gas containing hydrogen) can be supplied to the fuel electrode layer, and an oxidization gas (typically air containing oxygen) can be supplied to the air electrode layer; thereby the electrochemical element can serve as a fuel cell unit cell.

By contrast, in a case where a predetermined electric power is supplied between both electrodes, this electrochemical element can receive water supplied and can serve as an electrolytic element (electrolysis element) for decomposing the water. Hereinafter, electrolysis may be simply referred to as electrolytic.

Therefore, in the present invention, the electrochemical device is a fuel cell device in a case where the electrochemical element serves as a fuel cell, and the electrochemical device is an electrolysis device in a case where the electrochemical element serves as an electrolysis cell.

Since the coating composition produced by the method for producing the coating composition according to the present invention enables the yttria-stabilized zirconia layer to be easily produced, the coating composition can be adopted at least for the production of the electrolyte layer in the present invention. In addition, yttria-stabilized zirconia can also be used as a material for components other than the electrolyte layer used for the electrochemical element, such as a material for an electrode layer and a material for an interlayer that may be provided between the electrode layer and the electrolyte layer.

That is, as described in a fourteenth feature configuration of the present invention, the electrochemical element according to the present invention can be configured by providing the yttria-stabilized zirconia layer.

Here, as described in a fifteenth feature configuration of the present invention, it is preferable that the electrochemical element includes a metal support.

As a result of adopting this configuration, the electrochemical element can be supported by a robust metal support, and electrical conductivity required between electrochemical elements can be ensured.

As described in a sixteenth feature configuration of the present invention, an electrochemical module can be formed by assembling a plurality of the electrochemical elements described above.

According to this feature configuration, since the above-mentioned electrochemical elements are disposed in a state of being assembled, a compact, high-performance, strong, and reliable electrochemical module can be obtained while reducing material costs and processing costs.

As described in a seventeenth feature configuration of the present invention, an electrochemical device can be configured to include the electrochemical element or the electrochemical module, and a fuel converter that supplies a gas containing a reduction gas to the electrochemical element or the electrochemical module, or a fuel converter for converting a gas containing a reduction component generated from the electrochemical element or the electrochemical module.

As a result of adopting this configuration, in a case where the electrochemical element or electrochemical module serves as a fuel cell, hydrogen can be generated by a fuel converter such as a reformer from natural gas or the like supplied by using an existing raw fuel supply infrastructure such as a city gas. In a case where the electrochemical element or the electrochemical module operates as an electrolysis cell, for example, the electrochemical element or the electrochemical module serves as an electrochemical device that converts hydrogen generated by an electrolytic reaction of water into methane through a reaction with carbon monoxide or carbon dioxide in the fuel converter.

As described in an eighteenth feature configuration of the present invention, an electrochemical device is configured to include at least the electrochemical element or the electrochemical module, and an electric power converter that extracts electric power from the electrochemical element or the electrochemical module, or an electric power converter that supplies electric power to the electrochemical element or the electrochemical module.

As a result of adopting this configuration, the electric power converter converts the electric power extracted from the electrochemical element or the electrochemical module to be used for external use, or supplies the electric power from the outside to both the electrochemical element and the electrochemical module, so that the electrochemical element and the electrochemical module are used for electrolysis. For example, in a case where an inverter is used as the electric power converter, the electric power obtained from the electrochemical module is easily used since boosting can be performed by an inverter, or direct current can be converted into alternating current, which is preferable. On the other hand, in a case where the electrochemical element and the electrochemical module are used for electrolysis, a direct current can be obtained from an alternating-current power to construct an electrochemical device that can be used for electrolysis.

As described in a nineteenth feature configuration of the present invention, it is possible to construct an energy system including the electrochemical device described so far and an exhaust heat utilization section for reusing heat discharged from the electrochemical device.

According to the above-mentioned feature configuration, as a resulting of including the electrochemical device and the exhaust heat utilization section for reusing heat discharged from the electrochemical device, the energy system excellent in durability, reliability, and a performance, and also excellent in energy efficiency can be achieved. Moreover, a hybrid system having excellent energy efficiency can be achieved in combination with a power generation system which generates power by utilizing combustion heat of the unused fuel gas discharged from the electrochemical device.

Then, as described in a twentieth feature configuration of the present invention, a solid oxide fuel cell including the electrochemical element described so far and causing a power generation reaction with the electrochemical element can be obtained.

Meanwhile, as described in a twenty-first feature configuration of the present invention, a solid oxide electrolysis cell including the electrochemical element described so far and causing an electrolytic reaction with the electrochemical element can be obtained.

### BRIEF DESCRIPTION OF DRAWINGS

FIGS. 1(a) and 1(b) are diagrams illustrating production states of a coating composition.

FIGS. 2(a)-(d) are diagrams illustrating production states of the coating composition containing yttria-stabilized zirconia fine particles.

FIG. 3 is a diagram illustrating a coating state of the coating composition.

FIG. 4 is an XRD measurement result of the coating film of Example 1.

FIG. 5 is an XRD measurement result of the coating film of Example 2.

FIG. 6 is an XRD measurement result of the coating film of Example 3.

FIG. 7 is an XRD measurement result of the coating film of Example 4.

FIG. 8 is an XRD measurement result of the coating film of Example 5.

FIG. 9 is an XRD measurement result of the coating film of Example 6.

FIG. 10 is an XRD measurement result of the coating film of Example 7.

FIG. 11 is an XRD measurement result of the coating film of Example 8.

FIG. 12 is an XRD measurement result of the coating film of Example 9.

FIG. 13 is an XRD measurement result of the coating film of Example 10.

FIG. 14 is an XRD measurement result of the coating film of Example 11.

FIG. 15 is a cross-sectional view of the main part illustrating a configuration example of an electrochemical element.

FIG. 16 is a diagram illustrating a configuration example of an electrochemical module.

FIG. 17 is a diagram illustrating a configuration example of an electrochemical device that serves as a fuel cell device.

FIG. 18 is a cross-sectional view of the main part illustrating another configuration example of the electrochemical element.

FIG. 19 is a diagram illustrating another usage form in which the electrochemical element is used in an electrolytic reaction section.

FIG. 20 is a diagram illustrating another embodiment including the electrolytic reaction section, a reverse water gas shift reaction section, and a hydrocarbon synthesis reaction section.

### DESCRIPTION OF THE INVENTION

Hereinafter, the present invention will be specifically described based on Examples, but the present invention is not limited thereto.

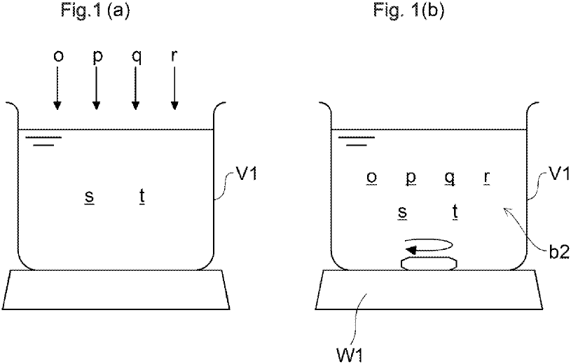

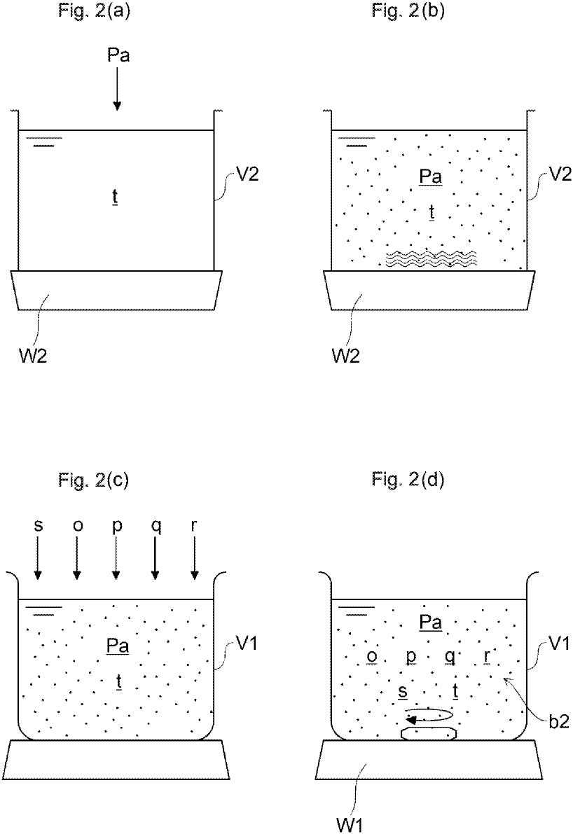

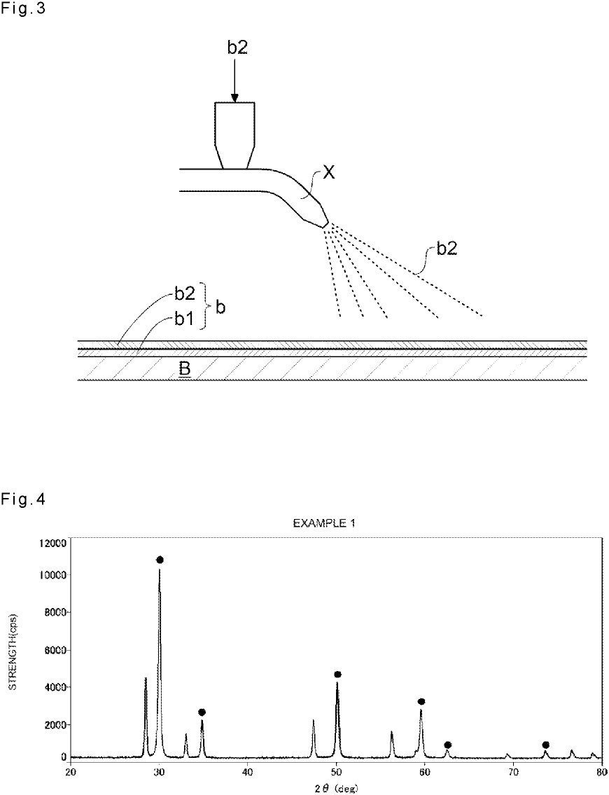

FIGS. 1(a) and (b) and 2(a)-(d) illustrate production states of a coating composition b2 according to the present invention, and FIG. 3 illustrates an example of a coating state thereof. FIGS. 1(a) and (b) illustrate an example in a case where the coating composition b2 does not contain the yttria-stabilized zirconia fine particles Pa described above, and FIGS. 2(a)-(d) illustrate an example in a case where the coating composition b2 contains the yttria-stabilized zirconia fine particles Pa.

As described above, the coating composition b2 produced by a method for producing a coating composition according to the present invention contains a zirconium alkoxide o, an yttrium compound p, a chelate compound q, a catalyst r, a water s, and an organic solvent t, which are in a mixed state. Furthermore, in a case of containing the yttria-stabilized zirconia fine particles Pa, the yttria-stabilized zirconia fine particles Pa are added. As illustrated in FIG. 3, this coating composition b2 is applied to a predetermined position, dried and calcinated to cure the coating composition; thereby an yttria-stabilized zirconia (YSZ) layer can be obtained.

Here, the zirconium alkoxide o is a starting raw material of the yttria-stabilized zirconia coating layer, and examples thereof include zirconium (IV) methoxide, zirconium (IV) ethoxide, zirconium (IV) n-propoxide, zirconium (IV) i-propoxide, zirconium (IV) n-butoxide, zirconium (IV) i-butoxide, zirconium (IV) sec-butoxide, or zirconium (IV) t-butoxide.

A content of this zirconium alkoxide o in the composition b2 is preferably 10% to 30% by mass.

In Examples and Comparative Examples described below, an example in which zirconium (IV) n-propoxide and zirconium (IV) n-butoxide are used is illustrated.

Examples of the yttrium compound p include yttrium nitrate, yttrium chloride, yttrium acetate, yttrium carbonate, yttrium (III) ethoxide, yttrium (III) n-propoxide, yttrium (III) i-propoxide, and the like.

A content of the yttrium compound p in the coating composition b2 is preferably 1% to 10% by mass.

In the following Examples and Comparative Examples, an example in which yttrium nitrate is used is illustrated.

Examples of the chelate compound q includes 2,4-pentanedione, 2,4-hexanedione, 3,5-heptanedione, 2,6-dimethyl-3,5-heptanedione, 2,2,6,6-tetramethyl-3,5-heptanedione, 1-phenyl-1,3-butanedione, 1,3-diphenyl-1,3-propanedione, 1,1,1-trifluoro-2,4-pentanedione, 1,1,1,5,5,5-hexafluoro-2,4-pentanedione, 1,3-cyclohexanedione, and the like.

The amount of the chelate compound q added is preferably about 0.5 to 3 mol with respect to 1 mol of zirconium alkoxide. A content of the chelate compound q in the coating composition b2 is preferably 5% to 20% by mass.

In the following Examples and Comparative Examples, an example in which 2,4-pentanedione, 3,5-heptanedione, 2,6-dimethyl-3,5-heptanedione, and 2,2,6,6-tetramethyl-3,5-heptanedione are used is illustrated.

Hydrochloric acid, acetic acid, nitric acid, sulfuric acid, phosphoric acid, and the like can be used as the catalyst r. A content of the catalyst r in the coating composition b2 is preferably 0.1% to 2% by mass. In the following Examples and Comparative Examples, an example in which nitric acid is used is illustrated.

Since the water s is also used for hydrolysis of the zirconium alkoxide o, it is difficult to achieve the purpose of a hydrolysis reaction proceeding with unique to the composition in a case of less than 0.25 mol, and even in a case of more than 1.0 mol, a further effect cannot be obtained. From the viewpoint of coatability and ease of handling of the coating composition b2, a content of the water s in the coating composition b2 is preferably within a range of about 0.1% to 2% by mass.

Examples of the organic solvent t include methanol, ethanol, 1-propanol, 2-propanol, 1-butanol, 2-methyl-1-propanol, 2-butanol, and 2-methyl-2-propanol. The organic solvent t is the remaining amount of other components.

In Examples and Comparative Examples described below, an example in which ethanol, 1-propanol, 2-propanol, and 1-butanol are used is illustrated.

As the yttria-stabilized zirconia fine particles Pa, a commercially available powder product can be used. A content in the coating composition b2 is preferably 1% to 10% by mass with respect to the zirconium alkoxide o. An average particle size of the yttria-stabilized zirconia fine particles Pa is preferably 0.1 to 2 µm. From the viewpoint of coatability and ease of handling of the coating composition b2, a content of the yttria-stabilized zirconia fine particles Pa in the coating composition b2 is preferably within a range of about 0.1% to 1% by mass.

### Examples and Comparative Examples

Examples 1 to 11 and Comparative Examples 1 to 4 illustrated below are examples in which, as illustrated in FIG. 3, the coating composition b2 according to the present invention was applied to an upper surface of a test piece B (ϕ25 × 3 mm, material of SUS430, a gadolinium-doped ceria b1 has been screen-printed on the surface) and was heat-treated at a predetermined temperature for a predetermined time, and an evaluation was performed on whether or not an yttria-stabilized zirconia layer that is a target layer is obtained.

As described later, the yttria-stabilized zirconia layer can be an electrolyte layer 4, but the gadolinium-doped ceria b1 is assumed as an interlayer 3 provided between the electrolyte layer 4 and an electrode layer 2 for forming the electrochemical element E (see paragraphs [124] to [134], and FIG. 15).

In FIGS. 1(a) and (b), as a mixing example, raw materials (zirconium alkoxide o, yttrium compound p, chelate compound q, catalyst r, water s, organic solvent t) were charged into a glass container V1 and mixed with each other by using a magnetic stirrer W1..

FIGS. 2(a)-(d) illustrate an example in which a resin container V2 was used to prepare a mixed solution of the yttria-stabilized zirconia fine particles Pa and the organic solvent t, which were mixed by using a vibration stirrer W2 (see FIGS. 2(a) and 2(b)), and thereafter, the remaining components (zirconium alkoxide o, yttrium compound p, chelate compound q, catalyst r, and water s) are charged into the glass container V1, and mixed by using the magnetic stirrer W1 (see FIGS. 2(c) and 2(d)).

FIG. 3 illustrates a state in which the coating composition b2 was being applied to a predetermined surface by using an air spray X. In the explanations of Examples and Comparative Examples described below, the reference numerals illustrated in the drawings are not marked in order to clarify the name and amount of each raw material used.

### 1. Example 1

5.65 g of zirconium (IV) n-propoxide, 1.65 g of yttrium nitrate hexahydrate, 3.45 g of 2,4-pentanedione, 0.27 g of 60% nitric acid, 0.12 g of water, and 38.85 g of 1-propanol were charged into a 150 ml glass container and were blended, and the mixture was stirred by using a magnetic stirrer for 3 hours to prepare 50 g of a coating composition. In this example, 1-propanol as a solvent is the same as an alcohol (1-propanol) corresponding to the alkoxide of the zirconium alkoxide.

Separately, the coating composition was applied to the test piece as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 1.5 µm.

In a case where the coating film was analyzed by X-ray diffraction, clear peaks of yttria-stabilized zirconia were found at 30, 35, 50, 60, 62, and 74 of 2θ as illustrated in FIG. 4. In addition, peaks of lower ceria were observed at 29, 33, 48, 56, 59, 69, 77, and 79 of 2θ.

Hereinafter, FIGS. 4 to 14 illustrate X-ray diffraction results of Examples. In FIGS. 4 to 14, “·” indicates peaks of yttria-stabilized zirconia.

### 2. Example 2

5.79 g of zirconium (IV) n-propoxide, 1.69 g of yttrium nitrate hexahydrate, 2.27 g of 3,5-heptanedione, 0.28 g of 60% nitric acid, 0.13 g of water, and 39.84 g of 1-propanol were charged into a 150 ml glass container and were blended, and the mixture was stirred by using a magnetic stirrer for 3 hours to prepare 50 g of a coating composition. In this example, 1-propanol as a solvent is the same as an alcohol (1-propanol) corresponding to the alkoxide of the zirconium alkoxide.

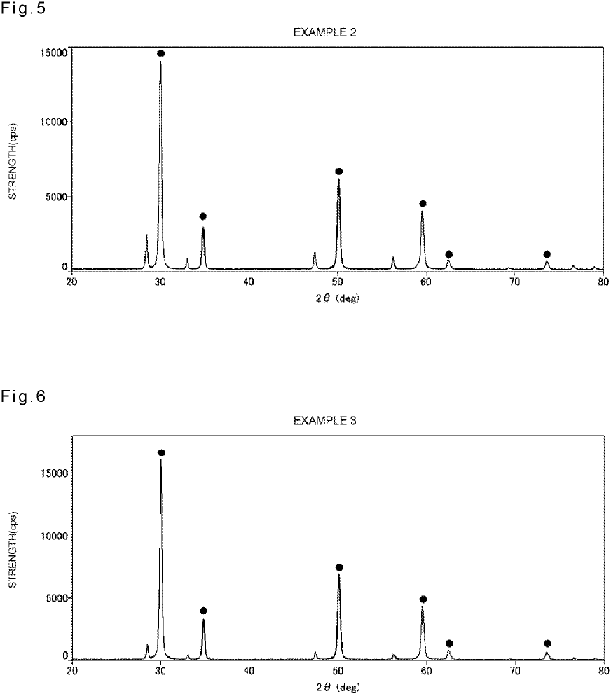

Separately, the coating composition was applied to the test piece as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 1.5 µm. In a case where the coating film was analyzed by X-ray diffraction, clear peaks of yttria-stabilized zirconia were found at 30, 35, 50, 60, 62, and 74 of 2θ as illustrated in FIG. 5. In addition, peaks of lower ceria were observed at 29, 33, 48, 56, 59, 69, 77, and 79 of 2θ.

### 3. Example 3

5.74 g of zirconium (IV) n-propoxide, 1.68 g of yttrium nitrate hexahydrate, 2.74 g of 2,6-dimethyl-3,5-heptanedione, 0.28 g of 60% nitric acid, 0.12 g of water, and 39.45 g of 1-propanol were charged into a 150 ml glass container and were blended, and the mixture was stirred by using a magnetic stirrer for 3 hours to prepare 50 g of a coating composition. In this example, 1-propanol as a solvent is the same as an alcohol (1-propanol) corresponding to the alkoxide of the zirconium alkoxide.

Separately, the coating composition was applied to the test piece as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 1.4 µm.

In a case where the coating film was analyzed by X-ray diffraction, clear peaks of yttria-stabilized zirconia were found at 30, 35, 50, 60, 62, and 74 of 2θ as illustrated in FIG. 6. In addition, peaks of lower ceria were observed at 29, 33, 48, 56, 59, 69, 77, and 79 of 2θ.

### 4. Example 4

5.68 g of zirconium (IV) n-propoxide, 1.66 g of yttrium nitrate hexahydrate, 3.20 g of 2,2,6,6-tetramethyl-3,5-heptanedione, 0.27 g of 60% nitric acid, 0.12 g of water, and 39.07 g of 1-propanol were charged into a 150 ml glass container and were blended, and the mixture was stirred by using a magnetic stirrer for 3 hours to prepare 50 g of a coating composition. In this example, 1-propanol as a solvent is the same as an alcohol (1-propanol) corresponding to the alkoxide of the zirconium alkoxide.

Separately, the coating composition was applied to the test piece as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 1.2 µm.

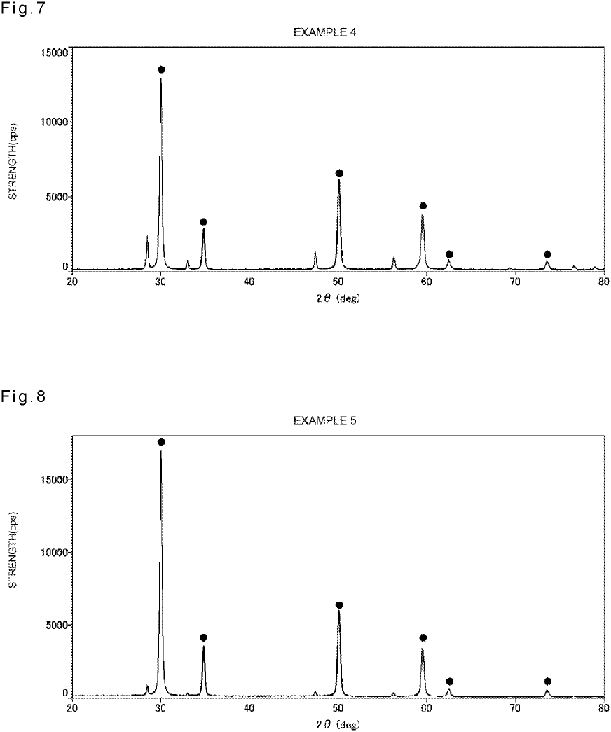

In a case where the coating film was analyzed by X-ray diffraction, clear peaks of yttria-stabilized zirconia were found at 30, 35, 50, 60, 62, and 74 of 2θ as illustrated in FIG. 7. In addition, peaks of lower ceria were observed at 29, 33, 48, 56, 59, 69, 77, and 79 of 2θ.

### 5. Example 5

6.90 g of zirconium (IV) n-propoxide, 2.02 g of yttrium nitrate hexahydrate, 4.22 g of 2,4-pentanedione, 0.33 g of 60% nitric acid, 0.15 g of water, and 36.39 g of ethanol were charged into a 150 ml glass container and were blended, and the mixture was stirred by using a magnetic stirrer for 3 hours to prepare 50 g of a coating composition. In this example, ethanol as a solvent is an alcohol corresponds to an alcohol having a smaller number of carbon atoms than the alcohol (1-propanol) corresponding to the alkoxide of the zirconium alkoxide.

Separately, the coating composition was applied to a test piece B as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 3.6 µm.

In a case where the coating film was analyzed by X-ray diffraction, clear peaks of yttria-stabilized zirconia were found at 30, 35, 50, 60, 62, and 74 of 2θ as illustrated in FIG. 8. In addition, peaks of lower ceria were observed at 29, 33, 48, 56, 59, 69, 77, and 79 of 2θ.

### 6. Example 6

5.51 g of zirconium (IV) n-butoxide, 1.38 g of yttrium nitrate hexahydrate, 2.88 g of 2,4-pentanedione, 0.23 g of 60% nitric acid, 0.10 g of water, and 39.91 g of 1-butanol were charged into a 150 ml glass container and were blended, and the mixture was stirred by using a magnetic stirrer for 3 hours to prepare 50 g of a coating composition. In this example, 1-butanol as a solvent is the same as an alcohol (1-butanol) corresponding to the alkoxide of the zirconium alkoxide.

Separately, the coating composition was applied to a test piece B as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 1.3 µm.

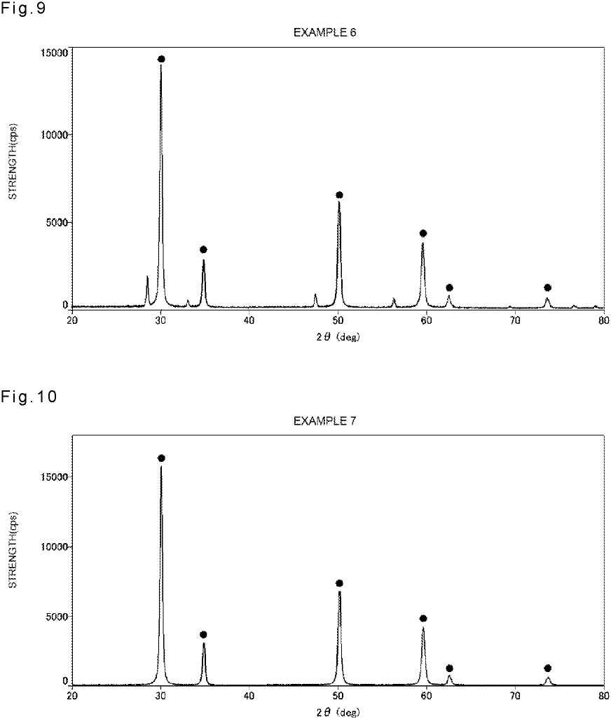

In a case where the coating film was analyzed by X-ray diffraction, clear peaks of yttria-stabilized zirconia were found at 30, 35, 50, 60, 62, and 74 of 2θ as illustrated in FIG. 9. In addition, peaks of lower ceria were observed at 29, 33, 48, 56, 59, 69, 77, and 79 of 2θ.

### 7. Example 7

6.49 g of zirconium (IV) n-butoxide, 1.62 g of yttrium nitrate hexahydrate, 3.39 g of 2,4-pentanedione, 0.27 g of 60% nitric acid, 0.12 g of water, and 36.49 g of 2-propanol were charged into a 150 ml glass container and were blended, and the mixture was stirred by using a magnetic stirrer for 3 hours to prepare 50 g of a coating composition. In this example, 2-propanol as a solvent is an alcohol corresponds to an alcohol having a smaller number of carbon atoms than the alcohol (1-butanol) corresponding to the alkoxide of the zirconium alkoxide.

Separately, the coating composition was applied to the test piece as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 3.6 µm.

In a case where the coating film was analyzed by X-ray diffraction, clear peaks of yttria-stabilized zirconia were found at 30, 35, 50, 60, 62, and 74 of 2θ as illustrated in FIG. 10. In addition, peaks of lower ceria were observed at 29, 33, 48, 56, 59, 69, 77, and 79 of 2θ.

### 8. Example 8

6.49 g of zirconium (IV) n-butoxide, 1.62 g of yttrium nitrate hexahydrate, 3.39 g of 2,4-pentanedione, 0.27 g of 60% nitric acid, 0.12 g of water, and 36.49 g of 1-propanol were charged into a 150 ml glass container and were blended, and the mixture was stirred by using a magnetic stirrer for 3 hours to prepare 50 g of a coating composition. In this example, 1-propanol as a solvent is an alcohol corresponds to an alcohol having a smaller number of carbon atoms than the alcohol (1-butanol) corresponding to the alkoxide of the zirconium alkoxide.

Separately, the coating composition was applied to a test piece B as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 3.6 µm.

In a case where the coating film was analyzed by X-ray diffraction, clear peaks of yttria-stabilized zirconia were found at 30, 35, 50, 60, 62, and 74 of 2θ as illustrated in FIG. 11. In addition, peaks of lower ceria were observed at 29, 33, 48, 56, 59, 69, 77, and 79 of 2θ.

### 9. Example 9

7.89 g of zirconium (IV) n-butoxide, 1.97 g of yttrium nitrate hexahydrate, 4.12 g of 2,4-pentanedione, 0.32 g of 60% nitric acid, 0.15 g of water, and 35.55 g of ethanol were charged into a 150 ml glass container and were blended, and the mixture was stirred by using a magnetic stirrer for 3 hours to prepare 50 g of a coating composition. In this example, ethanol as a solvent is an alcohol corresponds to an alcohol having a smaller number of carbon atoms than the alcohol (1-butanol) corresponding to the alkoxide of the zirconium alkoxide.

Separately, the coating composition was applied to a test piece B as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 3.6 µm.

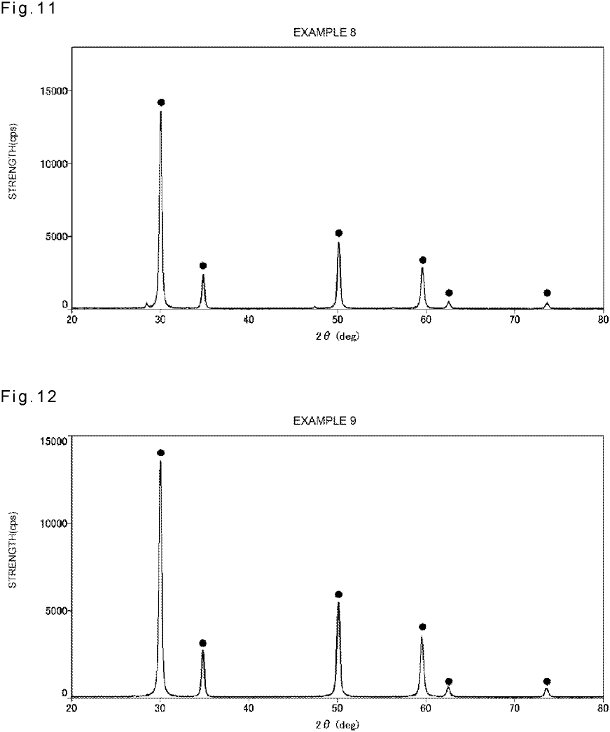

In a case where the coating film was analyzed by X-ray diffraction, clear peaks of yttria-stabilized zirconia were found at 30, 35, 50, 60, 62, and 74 of 2θ as illustrated in FIG. 12. In addition, peaks of lower ceria were observed at 29, 33, 48, 56, 59, 69, 77, and 79 of 2θ.

### 10. Example 10

5 g of yttria-stabilized zirconia (8YSZ) fine particles having an average particle size of 0.2 µm was weighed in a 200 ml resin container, and 95 g of 1-propanol was added. The mixture was stirred for 2 hours by using a vibration stirrer to prepare a 1-propanol dispersion of 8YSZ fine particles.

5.65 g of zirconium (IV) n-propoxide, 1.65 g of yttrium nitrate hexahydrate, 3.45 g of 2,4-pentanedione, 0.27 g of 60% nitric acid, 0.12 g of water, 5.65 g of a 1-propanol dispersion of the yttria-stabilized zirconia (8YSZ) fine particles (5% by weight of zirconium (IV) n-propoxide), and 30.78 g of 1-propanol were charged into a 150 ml glass container and were blended, and the mixture was stirred by using a magnetic stirrer for 3 hours to prepare 50 g of a coating composition. In this example, 1-propanol as a solvent is the same as an alcohol (1-propanol) corresponding to the alkoxide of the zirconium alkoxide.

Separately, the coating composition was applied to the test piece as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 2.1 µm.

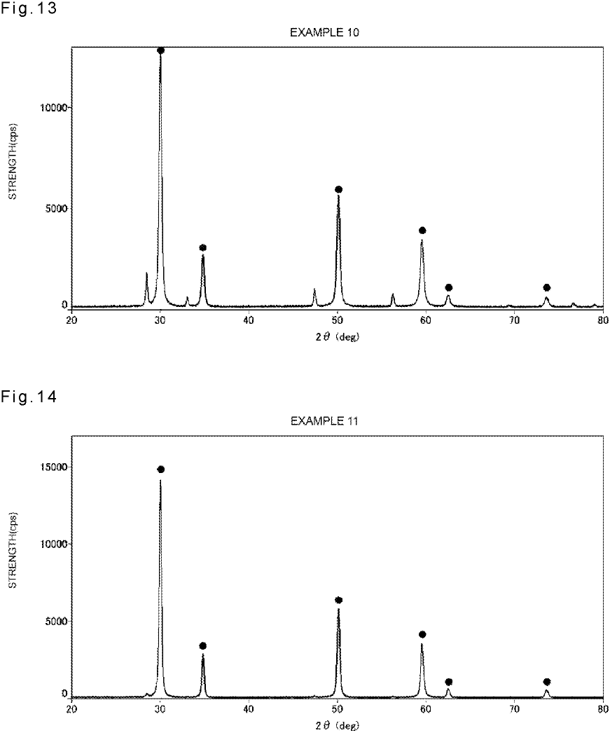

In a case where the coating film was analyzed by X-ray diffraction, clear peaks of yttria-stabilized zirconia were found at 30, 35, 50, 60, 62, and 74 of 2θ as illustrated in FIG. 13. In addition, peaks of lower ceria were observed at 29, 33, 48, 56, 69, 77, and 79 of 2θ.

### 11. Example 11

5 g of yttria-stabilized zirconia (8YSZ) fine particles having an average particle size of 0.2 µm was weighed in a 200 ml resin container, and 95 g of 1-propanol was added. The mixture was stirred for 2 hours by using a vibration stirrer to prepare a 1-propanol dispersion of 8YSZ fine particles.

5.79 g of zirconium (IV) n-propoxide, 1.69 g of yttrium nitrate hexahydrate, 2.27 g of 3,5-heptanedione, 0.28 g of 60% nitric acid, 0.13 g of water, 5.79 g of a 1-propanol dispersion of the yttria-stabilized zirconia (8YSZ) fine particles (5% by weight of zirconium (IV) n-propoxide), and 31.57 g of 1-propanol were charged into a 150 ml glass container and were blended, and the mixture was stirred by using a magnetic stirrer for 3 hours to prepare 50 g of a coating composition. In this example, 1-propanol as a solvent is the same as an alcohol (1-propanol) corresponding to the alkoxide of the zirconium alkoxide.

Separately, the coating composition was applied to the test piece as a subject by using an air spray and heat-treated at 80° C. for 30 minutes to prepare a coating film. Furthermore, the coating film was held at 1000° C. for 60 minutes to prepare a coating film. There was no damage such as cracking or peeling of the coating film, and a film thickness was 2.0 µm.

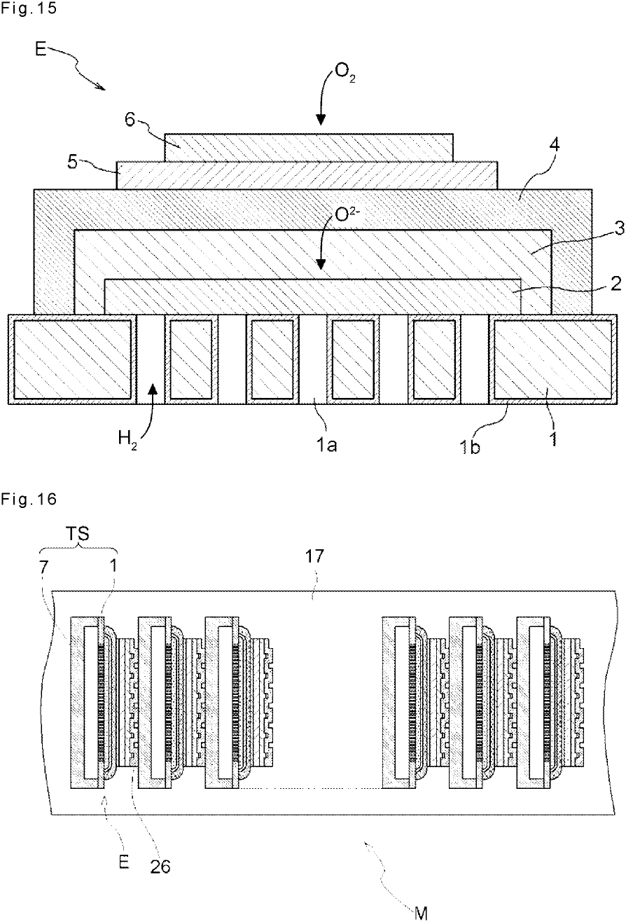

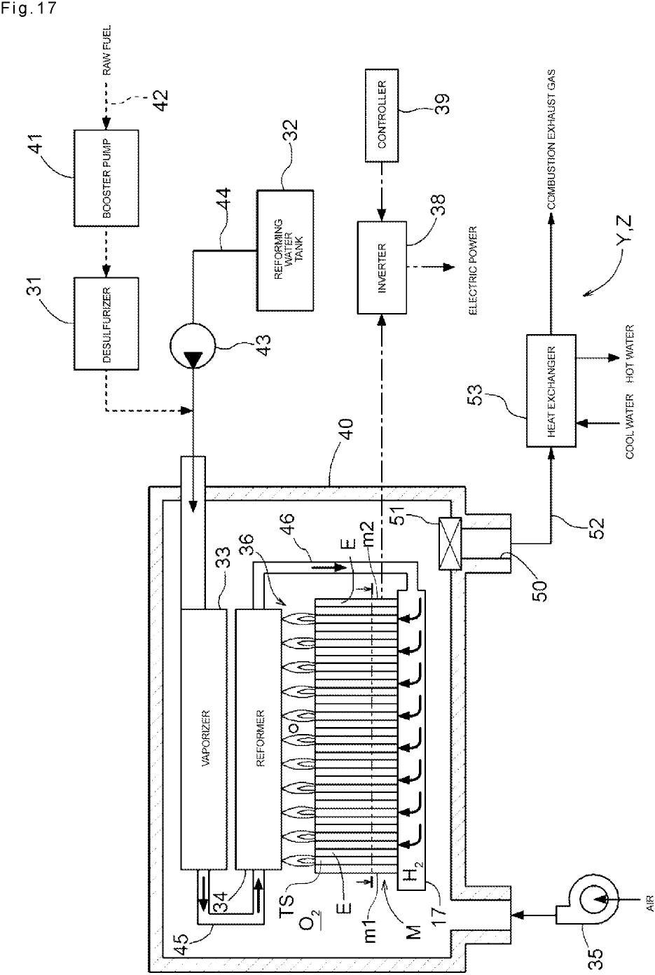

In a case where the coating film was analyzed by X-ray diffraction, clear peaks of yttria-stabilized zirconia were found at 30, 35, 50, 60, 62, and 74 of 2θ as illustrated in FIG. 14. In addition, peaks of lower ceria were observed at 29, 33, 48, 56, 69, 77, and 79 of 2θ.

### 8. Comparative Example 1 (Without Chelate Compound)

6.07 g of zirconium (IV) n-propoxide, 1.77 g of yttrium nitrate hexahydrate, 0.29 g of 60% nitric acid, 0.13 g of water, and 41.74 g of 1-propanol were charged into a 150 ml glass container and were blended, and the mixture was stirred by using a magnetic stirrer for 3 hours to prepare 50 g of a coating composition. No chelate agent was used as the chelate compound. In this example, 1-propanol as a solvent is the same as an alcohol (1-propanol) corresponding to the alkoxide of the zirconium alkoxide.

Separately, in a case where the coating composition was applied to the test piece as a subject by using an air spray and heat-treated at 80° C. for 30 minutes, cracks occurred on the entire surface of the coating film, and peeling was observed. Since peeling was observed on the coating film at the time of drying at 80° C., calcinating (holding) at 1000° C. was not carried out.

In Comparative Example 1, it is considered that hydrolysis of zirconium (IV) propoxide and a polycondensation reaction proceeded rapidly since the chelate compound was not added, so that cracks occurred on the front surface of the coating film, resulting in peeling off.

### 9. Comparative Example 2 (Without Nitric Acid)

5.68 g of zirconium (IV) n-propoxide, 1.66 g of yttrium nitrate hexahydrate, 3.47 g of 2,4-pentanedione, 0.12 g of water, and 39.07 g of 1-propanol were charged into a 150 ml glass container and were blended, and the mixture was stirred by using a magnetic stirrer for 3 hours to prepare 50 g of a coating composition. The 60% nitric acid was not used as a catalyst. In this example, 1-propanol as a solvent is the same as an alcohol (1-propanol) corresponding to the alkoxide of the zirconium alkoxide.

Separately, in a case where the coating composition was applied to the test piece as a subject by using an air spray and heat-treated at 80° C. for 30 minutes, cracks occurred on an end portion (outer circumferential portion) of the coating film, and peeling was observed. Since peeling was observed on the coating film at the time of drying at 80° C., calcinating at 1000° C. was not carried out.

In Comparative Example 2, it is considered that hydrolysis of zirconium (IV) n-propoxide and a polycondensation reaction proceeded ununiformly since the nitric acid as the catalyst was not added, so that cracks occurred on the end portion of the coating film, resulting in peeling off.

### 10. Comparative Example 3 (Without Nitric Acid and Water)

5.69 g of zirconium (IV) n-propoxide, 1.66 g of yttrium nitrate hexahydrate, 3.48 g of 2,4-pentanedione, and 39.16 g of 1-propanol were charged into a 150 ml glass container and were blended, and the mixture was stirred by using a magnetic stirrer for 3 hours to prepare 50 g of a coating composition. The 60% nitric acid and water were not used as a catalyst. In this example, 1-propanol as a solvent is the same as an alcohol (1-propanol) corresponding to the alkoxide of the zirconium alkoxide.

Separately, in a case where the coating composition was applied to the test piece as a subject by using an air spray and heat-treated at 80° C. for 30 minutes, cracks occurred on an end portion (outer circumferential portion) of the coating film, and peeling was observed similar to Comparative Example 2. Since peeling was observed on the coating film at the time of drying at 80° C., calcinating at 1000° C. was not carried out.

In Comparative Example 3, it is considered that hydrolysis of zirconium (IV) n-propoxide was insufficient, and a polycondensation reaction proceeded partially since the nitric acid as the catalyst and water were not added, so that cracks occurred on the end portion of the coating film, resulting in peeling off.

11. Comparative Example 4 (Reproduction of Example described in JP-A-H7-235317)

An equal amount of a 0.5 M-1-propanol solution of zirconium (IV) n-propoxide and a 0.087 M-1-propanol solution of yttrium nitrate hexahydrate were mixed, and a 0.5 M-1-propanol solution of 2,4-pentanedione was then added in a 150 ml glass container so that zirconium was contained in a ratio of 2 (molar ratio) to 2,4-pentanedione to prepare 50 g of a coating composition. In this example, 1-propanol as a solvent is the same as an alcohol (1-propanol) corresponding to the alkoxide of the zirconium alkoxide.

Separately, in a case where the coating composition was applied to the test piece as a subject by using an air spray and heat-treated at 80° C. for 30 minutes, the entire surface of the coating film was scabrous and had rough appearance, and the coating film was easily peeled off by a simple touch with a finger. Since peeling was observed on the coating film at the time of drying at 80° C., calcinating at 1000° C. was not carried out.

In Comparative Example 4, it is considered that hydrolysis of zirconium (IV) n-propoxide was insufficient, and a polycondensation reaction proceeded partially since the nitric acid as the catalyst and water were not added, so that the entire surface of the coating film was scabrous and had rough appearance, and the coating film was easily peeled off.

Examples of combinations for obtaining the suitable coating composition b2 and the yttria-stabilized zirconia coating film by using the zirconium alkoxide o, the yttrium compound p, the chelate compound q, the catalyst r, the water s, and the organic solvent t include the following combinations in addition to the combinations described in Examples 1 to 11. However, the present invention is not limited to these combinations. The following combinations can be selected regardless of the addition and content of the yttria-stabilized zirconia fine particles Pa.
a) Zirconium (IV) n-propoxide, yttrium (III) i-propoxide, 2,4-pentanedione, nitric acid, water, and 1-propanol
a) Zirconium (IV) n-propoxide, yttrium (III) i-propoxide, 3,5-heptanedione, nitric acid, water, and 1-propanol
c) Zirconium (IV) i-propoxide, yttrium (III) i-propoxide, 2,4-pentanedione, nitric acid, water, and 2-propanol
d) Zirconium (IV) i-propoxide, yttrium (III) i-propoxide, 3,5-heptanedione, nitric acid, water, and 2-propanol
e) Zirconium (IV) n-butoxide, yttrium acetate, 2,4-pentanedione, acetic acid, water, and 1-butanol
f) Zirconium (IV) n-butoxide, yttrium acetate, 3,5-heptanedione, acetic acid, water, and 1-butanol
g) Zirconium (IV) n-propoxide, yttrium chloride, 2,4-pentanedione, hydrochloric acid, water, and 1-propanol
h) Zirconium (IV) n-propoxide, yttrium chloride, 3,5-heptanedione, hydrochloric acid, water, and 1-propanol
i) Zirconium (IV) n-propoxide, yttrium sulfate, 2,4-pentanedione, sulfuric acid, water, and 1-propanol
j) Zirconium (IV) n-propoxide o, yttrium sulfate, 3,5-heptanedione, sulfuric acid, water, and 1-propanol

### Usage Form of Yttria-Stabilized Zirconia Layer

Hereinafter, a solid oxide fuel cell that is configured to include an electrochemical element E, this electrochemical element E being formed by using the yttria-stabilized zirconia layer described so far will be described with reference to FIGS. 15 to 18.

The electrochemical element E is used as, for example, a component of a solid oxide fuel cell that generates power by receiving a fuel gas containing hydrogen and air.

Hereinafter, in a case of expressing a positional relationship of layers in the description related to the electrochemical element E, a reference layer in the position notation is referred to as the electrolyte layer 4, the counter electrode layer 6 side as viewed from the electrolyte layer 4 is “upper” or an “upper side” (upper side in FIG. 15), and the electrode layer 2 side may be referred to as “lower” or a “lower side”. In addition, a surface of a metal substrate 1 on which the electrode layer 2 is formed (upper side in FIG. 15) may be referred to as a “front side”, and a surface on the opposite side (lower side in FIG. 15) may be referred to as a “back side”.

### Electrochemical Element

As illustrated in FIG. 15, the electrochemical element E includes the metal substrate 1 (an example of the metal support), the electrode layer 2 formed on the metal substrate 1, the interlayer 3 formed on the electrode layer 2, and the electrolyte layer 4 formed on the interlayer 3. The electrochemical element E further includes the reaction preventing layer 5 formed on the electrolyte layer 4 and the counter electrode layer 6 formed on the reaction preventing layer 5. That is, the counter electrode layer 6 is formed over the electrolyte layer 4, and the reaction preventing layer 5 is formed between the electrolyte layer 4 and the counter electrode layer 6. The electrode layer 2 and the counter electrode layer 6 are porous, and the electrolyte layer 4 is dense.

As described above, regarding each layer constituting the electrochemical element E, the main elements thereof are the electrolyte layer 4, the electrode layer 2 and the counter electrode layer 6 which are provided to sandwich the electrolyte layer 4, and these three layers can be provided to operate as the electrochemical element E.

### Metal Substrate

The metal substrate 1 serves as a support that supports the electrode layer 2, the interlayer 3, the electrolyte layer 4, and the like to maintain the strength of the electrochemical element E. Although the plate-shaped metal substrate 1 is used as this metal substrate, other shapes such as a box shape, a cylindrical shape, and a disk shape are also can be used as the metal support.

The metal substrate 1 has the strength as long as the strength enables the electrochemical element E to be sufficiently formed as a support, and for example, it is possible to use the metal substrate 1 having a thickness of about 0.1 mm to 2 mm, preferably about 0.1 mm to 1 mm, and more preferably about 0.1 mm to 0.5 mm.

The metal substrate 1 has a plurality of through-holes 1a provided to penetrate a front surface and a back surface. Furthermore, for example, the through-hole 1a can be provided in the metal substrate 1 by mechanical, chemical, or optical boring processing. The through-hole 1a has a function of allowing a gas to permeate from the back surface to the front surface of the metal substrate 1. In order to impart gas permeability to the metal substrate 1, it is also possible to use a porous metal. For example, for the metal substrate 1, a sintered metal, a foamed metal, or the like can also be used. As a metal substrate material, a ferrite stainless steel material (an example of Fe—Cr alloy) is used. Furthermore, as illustrated in FIG. 15, a coating layer 1b may be formed on an outer surface (including surfaces of the through-holes 1a) of this metal substrate 1. This coating layer 1b can be a metal oxide layer. For example, a Fe—Cr alloy can be subjected to a Co coating treatment, and can be then subjected to an oxidation treatment to form a metal oxide layer.

In a case where the Fe—Cr alloy is used as a material for the metal substrate 1, a thermal expansion coefficient of this material is close to that of yttria-stabilized zirconia (YSZ) or gadolinium-doped ceria (GDC, also referred to as CGO) used as a material for the electrode layer 2 or the electrolyte layer 4. As a result, even in a case where a temperature cycle of a low temperature and a high temperature is repeated, the electrochemical element E is less likely to be damaged. Accordingly, an electrochemical element E having excellent long-term durability can be obtained, which is preferable.

### Electrode Layer

As illustrated in FIG. 15, the electrode layer 2 can be provided as a thin layer in a region which is on the surface of the front side of the metal substrate 1 and is larger than a region where the through-holes 1a are provided. In a case of being provided as a thin layer, a thickness thereof can be, for example, about 1 µm to 100 µm and preferably 5 µm to 50 µm. In a case where the thickness is set as described above, a sufficient electrode performance can be ensured while reducing a cost by reducing a used amount of an expensive material for the electrode layer. The entire region where the through-holes 1a are provided is covered with the electrode layer 2. That is, the through-hole 1a is formed inside a region of the metal substrate 1 where the electrode layer 2 is formed. In other words, all the through-holes 1a are provided so as to face the electrode layer 2.

As a material for the electrode layer 2, for example, a composite material such as NiO—GDC, Ni—GDC, NiO—YSZ, Ni—YSZ, CuO—CeO₂, and Cu—CeO₂ can be used. In these examples, YSZ, GDC, and CeO₂ can be referred to as a composite aggregate. In addition, the electrode layer 2 is preferably formed by a low-temperature calcination method (for example, a wet method using a calcination treatment in a low-temperature range without performing a calcination treatment in a high-temperature range of higher than 1,100° C.), a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), a CVD method, or the like. As a result of adopting these processes which can be used in a low-temperature range, a favorable electrode layer 2 can be obtained without using calcination in a high-temperature range of higher than 1,100° C., for example. For the reason, the element interdiffusion between the metal substrate 1 and the electrode layer 2 can be suppressed without damaging the metal substrate 1, and an electrochemical element having excellent durability can be obtained, which is preferable. Furthermore, using the low-temperature calcination method is more preferable because handling of raw materials becomes easy.

The electrode layer 2 has a plurality of pores inside and on the surface thereof so as to have gas permeability. That is, the electrode layer 2 is formed as a porous layer. The electrode layer 2 is formed, for example, so that the denseness is 30% or greater and less than 80%. As a size of the pore, a size suitable for allowing an electrochemical reaction to smoothly proceed during the reaction can be appropriately selected. Moreover, the denseness is a proportion of a material constituting a layer to a space, can be expressed as (1 -porosity), and is equivalent to a relative density.

### Interlayer

As illustrated in FIG. 15, the interlayer 3 can be formed as a thin layer on the electrode layer 2 in a state of covering the electrode layer 2. In a case of being provided as a thin layer, a thickness thereof can be, for example, about 1 µm to 100 µm, preferably about 2 µm to 50 µm, and more preferably about 4 µm to 25 µm. In a case where the thickness is set as described above, a sufficient performance can be ensured while reducing a cost by reducing a used amount of an expensive material for the interlayer. As a material for the interlayer 3, for example, yttria-stabilized zirconia (YSZ), scandia-stabilized zirconia (SSZ), gadolinium-doped ceria (GDC), yttrium-doped ceria (YDC), samarium-doped ceria (SDC), or the like can be used. In particular, ceria-based ceramics are suitably used.

The interlayer 3 is preferably formed by a low-temperature calcination method (for example, a wet method using a calcination treatment in a low-temperature range without performing a calcination treatment in a high-temperature range of higher than 1,100° C.), a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), a CVD method, or the like. As a result of adopting these film formation processes that can be used in a low-temperature range, the interlayer 3 can be obtained without using calcination in a high-temperature range of higher than 1,100° C., for example. For this reason, the element interdiffusion between the metal substrate 1 and the electrode layer 2 can be prevented without damaging the metal substrate 1, and an electrochemical element E having excellent durability can be achieved. Furthermore, using a low-temperature calcination method is still more preferable since handling of raw materials is easy.

The interlayer 3 preferably has oxygen ion (oxide ion) conductivity. In addition, the interlayer 3 more preferably has mixed conductivity of an oxygen ion (oxide ion) and an electron. The interlayer 3 having these properties is suitable for application to the electrochemical element E.

### Electrolyte Layer

The electrolyte layer 4 is formed as a thin layer on the interlayer 3 in a state of covering the electrode layer 2 and the interlayer 3, as illustrated in FIG. 15. The electrolyte layer 4 can also be formed as a thin film having a thickness of 10 µm or smaller. Specifically, the electrolyte layer 4 is provided over (provided on both) the interlayer 3 and the metal substrate 1. With such a configuration, the electrolyte layer 4 is bonded to the metal substrate 1; thereby the electrochemical element as a whole can have excellent fastness properties.

In addition, the electrolyte layer 4 is provided in a region which is on the surface of the front side of the metal substrate 1 and is larger than a region where the through-holes 1a are provided. That is, the through-holes 1a are formed inside a region of the metal substrate 1 where the electrolyte layer 4 is formed.

Furthermore, gas leakage from the electrode layer 2 and the interlayer 3 can be prevented at the periphery of the electrolyte layer 4. To explain, in a case where the electrochemical element E is used as a component of SOFC, gas is supplied from the back side of the metal substrate 1 to the electrode layer 2 through the through-holes 1a during the operation of SOFC. At a site where the electrolyte layer 4 is in contact with the metal substrate 1, gas leakage can be suppressed without providing a separate member such as a gasket. Moreover, in the present embodiment, the electrolyte layer 4 covers the entire periphery of the electrode layer 2, but a configuration in which the electrolyte layer 4 is provided on an upper part of the electrode layer 2 and the interlayer 3, and a gasket or the like is provided at the periphery may be adopted.

As a material for the electrolyte layer 4, yttria-stabilized zirconia (YSZ), scandia-stabilized zirconia (SSZ), gadolinium-doped ceria (GDC), yttrium-doped ceria (YDC), samarium-doped ceria (SDC), strontium- and magnesium-doped lanthanum gallate (LSGM), or the like can be used. In particular, zirconia-based ceramics are suitably used. In a case where the electrolyte layer 4 is made of the zirconia-based ceramics, an operating temperature of SOFC using the electrochemical element E can be made higher than that in a case of ceria-based ceramics. For example, in a case where the electrochemical element E is used for SOFC, and a system configuration in which a material, such as YSZ, which can exhibit a high electrolyte performance even in a high-temperature range of about 650° C. or higher is used as the material for the electrolyte layer 4, a hydrocarbon-based raw fuel such as a city gas and LPG is used as a raw fuel of the system, and the raw fuel is steam-reformed to become an anode gas of SOFC is adopted, it is possible to construct a highly efficient SOFC system in which heat generated in a cell stack of SOFC is used for reforming the raw fuel gas.

The electrolyte layer 4 is preferably formed by a low-temperature calcination method (a wet method using a calcination treatment in a low-temperature range without performing a calcination treatment in a high-temperature range of higher than 1,100° C.), and for example, the electrolyte layer 4 can be formed by performing an air spray method, a bar coat method, a dispenser method, a brush coating, and a spatula coating with a liquid composition, and performing a calcination treatment in a temperature range of 1100° C. or lower. In addition, the electrolyte layer 4 is preferably formed by a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), a CVD method, or the like. As a result of adopting these film formation processes that can be used in a low-temperature range, a electrolyte layer 4 that is dense and has high gastightness and gas barrier properties can be obtained without using calcination in a high-temperature range of higher than 1,100° C., for example. Therefore, the damage of the metal substrate 1 can be prevented, and the element interdiffusion between the metal substrate 1 and the electrode layer 2 can be prevented; thereby capable of achieving the electrochemical element E excellent in a performance and durability. In particular, using a low-temperature calcination method, a spray coating method, or the like is preferable because a low-cost element can be obtained. Furthermore, using the low-temperature calcination method and the spray coating method is more preferable because the electrolyte layer which is dense and has high gastightness and gas barrier properties can be easily obtained in a low-temperature range.

The electrolyte layer 4 is densely configured to shield gas leak of an anode gas and a cathode gas and to exhibit high ionic conductivity. A denseness of the electrolyte layer 4 is preferably 90% or greater, more preferably 95% or greater, and still more preferably 98% or greater. In a case where the electrolyte layer 4 is a uniform layer, the denseness thereof is preferably 95% or greater and more preferably 98% or greater. Moreover, when the electrolyte layer 4 is formed in a form of a plurality of layers, at least some of these layers preferably include a layer (a dense electrolyte layer) having a denseness of 98% or greater, and more preferably include a layer (a dense electrolyte layer) having a denseness of 99% or greater. This is because when such a dense electrolyte layer is included in a part of the electrolyte layer 4, the electrolyte layer that is dense and has high gastightness and gas barrier properties can be easily formed even in a case where the electrolyte layer 4 is formed in a form of a plurality of layers.

### Reaction Preventing Layer

The reaction preventing layer 5 can be formed as a thin layer on the electrolyte layer 4. In a case of being provided as a thin layer, a thickness thereof can be, for example, about 1 µm to 100 µm, preferably about 2 µm to 50 µm, and more preferably about 4 µm to 25 µm. In a case where the thickness is set as described above, a sufficient performance can be ensured while reducing a cost by reducing a used amount of an expensive material for the reaction preventing layer. As a material of the reaction preventing layer 5 may be any material that can prevent a reaction between a component of the electrolyte layer 4 and a component of the counter electrode layer 6. For example, a ceria-based material or the like is used. As a result of introducing the reaction preventing layer 5 between the electrolyte layer 4 and the counter electrode layer 6, a reaction between constituent materials of the counter electrode layer 6 and constituent materials of the electrolyte layer 4 can be effectively suppressed, and long-term stability of the performance of the electrochemical element E can be improved. Forming the reaction preventing layer 5 by appropriately using a method in which the reaction preventing layer 5 can be formed at a treatment temperature of 1,100° C. or lower is preferable since the damage of the metal substrate 1 can be prevented, the element interdiffusion between the metal substrate 1 and the electrode layer 2 can be prevented, and the electrochemical element E excellent in a performance and durability can be obtained. For example, the formation can be performed by appropriately using a low-temperature calcination method (for example, a wet method using a calcination treatment in a low-temperature range without performing a calcination treatment in a high-temperature range of higher than 1,100° C.), a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), a CVD method, or the like. In particular, using a low-temperature calcination method, a spray coating method, or the like is preferable because a low-cost element can be obtained. Furthermore, using the low-temperature calcination method is more preferable because handling of raw materials becomes easy.

### Counter Electrode Layer

The counter electrode layer 6 can be formed as a thin layer on the electrolyte layer 4 or the reaction preventing layer 5. In a case of being provided as a thin layer, a thickness thereof can be, for example, about 1 µm to 100 µm and preferably 5 µm to 50 µm. In a case where the thickness is set as described above, a sufficient electrode performance can be ensured while reducing a cost by reducing a used amount of an expensive material for the counter electrode layer. As a material for the counter electrode layer 6, for example, a complex oxide such as LSCF and lantern strontium manganate (LSM), a ceria-based oxide, and a mixture thereof can be used. In particular, the counter electrode layer 6 preferably contains a perovskite-type oxide containing two or more elements selected from the group consisting of La, Sr, Sm, Mn, Co, and Fe. The counter electrode layer 6 formed of the above materials functions as a cathode.

Forming the counter electrode layer 6 by appropriately using a method by which the counter electrode layer 6 can be formed at a treatment temperature of 1,100° C. or lower is preferable since the damage of the metal substrate 1 can be prevented, the element interdiffusion between the metal substrate 1 and the electrode layer 2 can be prevented, and the electrochemical element E excellent in a performance and durability can be obtained. For example, the formation can be performed by appropriately using a low-temperature calcination method (for example, a wet method using a calcination treatment in a low-temperature range without performing a calcination treatment in a high-temperature range of higher than 1,100° C.), a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), a CVD method, or the like. In particular, using a low-temperature calcination method, a spray coating method, or the like is preferable because a low-cost element can be obtained. Furthermore, using the low-temperature calcination method is more preferable because handling of raw materials becomes easy.

As described above, in the electrochemical element E according to the present invention, yttria-stabilized zirconia (YSZ) can be adopted for the electrolyte layer 4. The electrolyte layer 4 can be formed by using the coating composition b2 according to the present invention because of the advantage of obtaining the electrolyte layer 4 that is dense and that has high gastightness and gas barrier properties.

As another embodiment, an yttria-stabilized zirconia layer obtained by curing the coating composition b2 of the present application can be used as a part of the electrode layer 2 and the interlayer 3 (partial constituent material of a composite material). Furthermore, another interlayer (not illustrated) may be inserted between the electrolyte layer 4 and the reaction preventing layer 5, and the yttria-stabilized zirconia obtained by curing the coating composition b2 of the present application can also be used as a part of this interlayer.

### Operation as Solid Oxide Fuel Cell

As a result of configuring the electrochemical element E as described above, the electrochemical element E can be used as a fuel cell of a solid oxide fuel cell. For example, a reduction gas (typically a fuel gas containing hydrogen) is supplied to the electrode layer 2 from the back surface of the metal substrate 1 through the through-holes 1a, and an oxidization gas (typically air containing oxygen) is supplied to the counter electrode layer 6 serving as a counter electrode of the electrode layer 2 to operate the electrochemical element E at a temperature of, for example, 600° C. or higher and 850° C. or lower. Then, oxygen O₂ contained in the air in the counter electrode layer 6 reacts with an electron e⁻ to generate an oxygen ion O²⁻. The oxygen ion O²⁻ moves to the electrode layer 2 through the electrolyte layer 4 (see FIG. 15). In the electrode layer 2, hydrogen H₂ contained in the supplied fuel gas reacts with an oxygen ion O²⁻ to generate water H₂O and an electron e¯. As a result of the above reaction, an electromotive force is generated between the electrode layer 2 and the counter electrode layer 6. In this case, the electrode layer 2 functions as a fuel electrode (anode) of SOFC, and the counter electrode layer 6 functions as an air electrode (cathode).

### Method for Producing Electrochemical Element

Next, a method for producing the electrochemical element E according to the present embodiment will be described.

In the following description, an example of forming an yttria-stabilized zirconia layer on a part of the electrode layer 2 and the interlayer 3 and further on the electrolyte layer 4 by using the coating composition b2 according to the present invention will be mainly described.

### Metal Substrate Preparation Step

At a metal substrate preparation step, a plate material made of a Fe—Cr alloy having a predetermined shape can be prepared, and a large number of the through-holes 1a can be formed at predetermined positions of the plate material by laser processing or the like. This plate material may be subjected to a Co-plating treatment, and after the plating treatment, an oxidation treatment may be performed to form a metal oxide layer containing Co. This metal oxide layer will be formed as a metal oxide layer 1b (coating layer) in an electrode layer forming step described later.

### Electrode Layer Forming Step

In an electrode layer forming step, the electrode layer 2 is formed as a thin film in a region wider than the region where the through-holes 1a are provided on the front surface of the metal substrate 1 obtained at the metal substrate preparation step. The through-holes of the metal substrate 1 can be provided by laser processing or the like. The electrode layer 2 can be formed by appropriately using a low-temperature calcination method (a wet method with a calcination treatment in a low-temperature range of 1,100° C. or lower), a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), or the like. Regardless of which method is used, it is desirable to carry out a method at a temperature of 1100° C. or lower in order to prevent deterioration of the metal substrate 1.

In a case where the electrode layer forming step is carried out by a low-temperature calcination method, specifically, material powder and a solvent (dispersion medium) are mixed to prepare material paste, and the material paste is applied to the front surface of the metal substrate 1. Here, the coating composition b2 according to the present invention can be used as a part of this material paste.

Then, the electrode layer 2 is compression molded (electrode layer smoothing step) and calcinated at 1100° C. or lower (electrode layer calcination step). The compression molding of the electrode layer 2 can be carried out by, for example, cold isostatic pressing (CIP, cold hydrostatic pressure) molding, roll pressure molding, rubber isostatic pressing (RIP) molding, or the like. The electrode layer 2 is suitably calcinated at a temperature of 800° C. or higher and 1,100° C. or lower. The order of the electrode layer smoothing step and the electrode layer calcination step can be exchanged.

In a case of forming the electrochemical element including the interlayer 3, the electrode layer smoothing step or the electrode layer calcination step is not carried out, or the electrode layer smoothing step or the electrode layer calcination step can be included in an interlayer smoothing step or an interlayer calcination step described later.

The electrode layer smoothing step can also be carried out by performing a lap forming or leveling treatment, a surface cutting and polishing treatment, or the like.

### Diffusion Preventing Layer Forming Step

A diffusion preventing layer is the metal oxide layer 1b (coating layer) formed on the surface of the metal substrate 1 during a calcination step at the above-mentioned electrode layer forming step. In a case where the above-mentioned calcination step includes a calcination step carried out based on a condition of setting a calcinating atmosphere to an atmosphere with a low oxygen partial pressure, the effect of suppressing mutual diffusion of elements is high, and a high-quality metal oxide layer 1b having a low resistance value is formed, which is preferable. Including a case where the electrode layer forming step is carried out by a coating method without calcination, another diffusion preventing layer forming step may be included. For example, at the other diffusion preventing layer forming step, the metal substrate 1 is coated with Co thereon, and an oxidation treatment is then carried out to form the metal oxide layer 1b. Alternatively, for example, at the other diffusion preventing layer forming step, an intervening layer formed on the metal substrate 1 can be coated with Co, and the oxidation treatment can be then carried out to form the metal oxide layer 1b.

In both case, it is desirable to carry out the treatment at a treatment temperature of 1100° C. or lower, which can prevent damage to the metal substrate 1. In addition, the metal oxide layer 1b (diffusion preventing layer) may be formed on the surface of the metal substrate 1 during the calcination step at an interlayer forming step described later.

### Interlayer Forming Step

At an interlayer forming step, the interlayer 3 is formed as a thin layer on the electrode layer 2 in the form of covering the electrode layer 2. The interlayer 3 can be formed by appropriately using a low-temperature calcination method (a wet method with a calcination treatment in a low-temperature range of 1,100° C. or lower), a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), a CVD method, or the like. Regardless of which method is used, it is desirable to carry out a method at a temperature of 1100° C. or lower in order to prevent deterioration of the metal substrate 1.

In a case where the interlayer forming step is carried out by the low-temperature calcination method, it is specifically performed as in the following example. First, material powder of the interlayer 3 and a solvent (dispersion medium) are mixed to prepare material paste, and the material paste is applied to the front surface of the metal substrate 1.

As a material of the interlayer, ceria-based ceramics such as gadolinium-doped ceria (GDC), yttrium-doped ceria (YDC), and samarium-doped ceria (SDC) are suitably used. Here, in a case where the coating composition b2 according to the present invention is contained in this material paste in advance, it can be used as a part of the interlayer 3 made of a composite material.

Then, the interlayer 3 is compression molded (interlayer smoothing step) and calcinated at 1100° C. or lower (interlayer calcination step). The compression molding of the interlayer 3 can be carried out by, for example, cold isostatic pressing (CIP, cold hydrostatic pressure) molding, roll pressure molding, rubber isostatic pressing (RIP) molding, or the like. The interlayer 3 is suitably calcinated at a temperature of 800° C. or higher and 1100° C. or lower. The reason why such a temperature is employed is because a high-strength interlayer 3 can be formed while preventing damage and deterioration of the metal substrate 1. In addition, the interlayer 3 is preferably calcinated at 1050° C. or lower and still more preferably calcinated at 1000° C. or lower. This is because the electrochemical element E can be formed while further preventing damage and deterioration of the metal substrate 1 as the calcination temperature of the interlayer 3 is lowered. The order of the interlayer smoothing step and the interlayer calcination step can be exchanged.

The interlayer smoothing step can also be carried out by performing a lap forming or leveling treatment, a surface cutting and polishing treatment, or the like.

### Electrolyte Layer Forming Step

At an electrolyte layer forming step, the electrolyte layer 4 is formed as a thin layer on the interlayer 3 in a state of covering the electrode layer 2 and the interlayer 3. The electrolyte layer 4 can also be formed as a thin film having a thickness of 10 µm or less. The electrolyte layer 4 is preferably formed by the low-temperature calcination method (a wet method of performing a calcination treatment in a low-temperature range of 1100° C. or lower) as described above, and for example, the electrolyte layer 4 can be formed by performing an air spray method, a bar coat method, a dispenser method, a brush coating, and a spatula coating with the coating composition b2 according to the present invention, and performing a calcination treatment in a temperature range of 1100° C. or lower. In addition, it is possible to use methods such as a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), and a CVD method. Regardless of which method is used, it is desirable to carry out a method at a temperature of 1100° C. or lower in order to prevent deterioration of the metal substrate 1.

In order to form a high-quality electrolyte layer 4 that is dense and has high gastightness and gas barrier properties in a temperature range of 1100° C. or lower, it is desirable that the coating composition b2 according to the present invention is used to form the electrolyte layer 4 in the electrolyte layer forming step by a low-temperature calcination method. In that case, a material of the electrolyte layer 4 can be applied onto an underlying layer by an air spray method or the like and can be subjected to a calcination treatment at a temperature of 1100° C. or lower to form the electrolyte layer 4.

### Reaction Preventing Layer Forming Step

At the reaction preventing layer forming step, the reaction preventing layer 5 is formed on the electrolyte layer 4 as a thin layer. The reaction preventing layer 5 can be formed by appropriately using a low-temperature calcination method, a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), a CVD method, or the like. Regardless of which method is used, it is desirable to carry out a method at a temperature of 1100° C. or lower in order to prevent deterioration of the metal substrate 1. In order to flatten an upper surface of the reaction preventing layer 5, for example, a leveling treatment or a surface cutting and polishing treatment may be performed after forming the reaction preventing layer 5, or press processing may be performed after wet formation and before calcination.

### Counter Electrode Layer Forming Step

At the counter electrode layer forming step, the counter electrode layer 6 is formed on the reaction preventing layer 5 as a thin layer. The counter electrode layer 6 can be formed by appropriately using a low-temperature calcination method, a spray coating method (a method such as a thermal spraying method, an aerosol deposition method, an aerosol gas deposition method, a powder jet deposition method, a particle jet deposition method, and a cold spraying method), a PVD method (a sputtering method, a pulsed laser deposition method, or the like), a CVD method, or the like. Regardless of which method is used, it is desirable to carry out a method at a temperature of 1100° C. or lower in order to prevent deterioration of the metal substrate 1.

As described above, the electrochemical element E can be produced. A base material with an electrode layer for a metal-supported electrochemical element can be produced by performing the electrode layer forming step and the interlayer forming step described above.

A form in which the electrochemical element E does not include either or both the interlayer 3 and the reaction preventing layer 5 is possible. That is, a form in which the electrode layer 2 and the electrolyte layer 4 are formed to be in contact with each other or a form in which the electrolyte layer 4 and the counter electrode layer 6 are formed to be in contact with each other is also possible. In this case, in the above-mentioned producing method, the interlayer forming step and the reaction preventing layer forming step are not provided.

### Electrochemical Element, Electrochemical Module, and Electrochemical Device

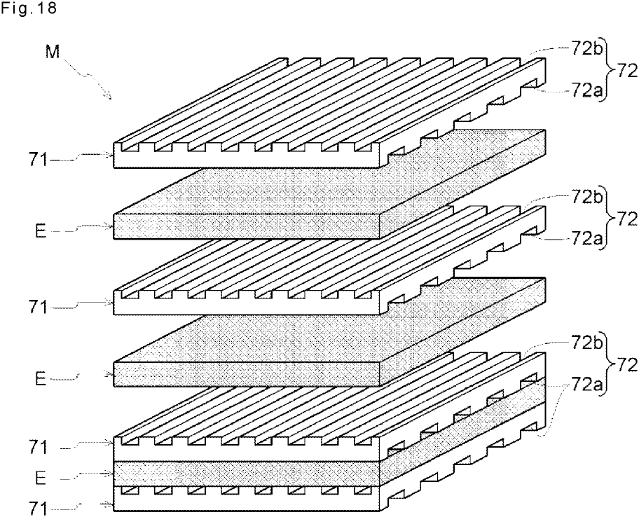

An example of a solid oxide fuel cell with an electrochemical element E, an electrochemical module M, an electrochemical device Y, and an energy system Z will be described with reference to FIGS. 16 and 17.

In the electrochemical element E of this form, as illustrated in FIG. 16, a U-shaped member 7 is attached to the back surface of the metal substrate 1, and the metal substrate 1 and the U-shaped member 7 form a tubular support TS. The same material to form the metal substrate 1 (an alloy material in which a base material is a Fe—Cr alloy and a Co composite oxide film is formed on an outer surface thereof) can be used for the U-shaped member 7 (separator). In a case where the electrochemical element E serves as a fuel cell, a flow channel formed between the metal substrate 1 and the U-shaped member 7 serves as a supply channel for a reduction gas (typically, a fuel gas containing hydrogen).

As illustrated in FIG. 16, a plurality of the electrochemical elements E are stacked with a current-collecting member 26 interposed therebetween to form the electrochemical module M. Here, stacking is an example of assembling. The current-collecting member 26 is bonded to the counter electrode layer 6 of each electrochemical element E and the U-shaped member 7, and allows the counter electrode layer 6 of each electrochemical element E and the U-shaped member 7 to be electrically connected to each other. Therefore, integral and electrical connection is achieved in the electrochemical module M in a stacking direction. The same material to form the metal substrate 1 (an alloy material in which a base material is a Fe—Cr alloy and a composite oxide film containing Co is formed on an outer surface thereof) can also be used for the current-collecting member 26. The alloy member described above is used.

As illustrated in FIG. 17, the electrochemical module M includes a gas manifold 17, a terminal member ml, and a current extraction section m2. In the plurality of the electrochemical elements E stacked with the current-collecting member 26 interposed therebetween as illustrated in FIG. 16, one open end portion of the tubular support TS is connected to the gas manifold 17 to supply a gas from the gas manifold 17 (in this example, the reformed gas reformed by the reformer 34).

The supplied gas flows through the inside of the tubular support TS and is supplied to the electrode layer 2 through the through-holes 1a of the metal substrate 1.

FIG. 17 illustrates an outline of the energy system Z and the electrochemical device Y.

The energy system Z includes the electrochemical device Y and a heat exchanger 53 as an exhaust heat utilization section for reusing heat discharged from the electrochemical device Y.

The electrochemical device Y includes an electrochemical module M, a fuel supply section that includes a desulfurizer 31 and a reformer 34 and that supplies a fuel gas containing a reduction gas to the electrochemical module M, and an inverter 38 as an electric power conversion section for extracting electric power from the electrochemical module M. Therefore, this electrochemical device serves as a power generation device that receives fuel to generate electricity.

Specifically, the electrochemical device Y includes a desulfurizer 31, a reforming water tank 32, a vaporizer 33, a reformer 34, a blower 35, a combustion section 36, an inverter 38, a controller 39, a storage container 40, and an electrochemical module M.

The desulfurizer 31 removes (desulfurizes) a sulfur compound component contained in a hydrocarbon-based raw fuel such as a city gas. In a case where a sulfur compound is contained in a raw fuel, the desulfurizer 31 can be provided to suppress the influence of the sulfur compound on the reformer 34 or the electrochemical elements E. The vaporizer 33 produces steam from reforming water supplied from the reforming water tank 32. The reformer 34 steam-reforms a raw fuel desulfurized in the desulfurizer 31 by using the steam produced in the vaporizer 33 to produce a reformed gas containing hydrogen.

The electrochemical module M performs power generation by using a reformed gas supplied from the reformer 34 and air supplied from the blower 35 to cause an electrochemical reaction between the reformed gas and the air. In the combustion section 36, a reaction exhaust gas discharged from the electrochemical module M is mixed with air to combust combustible components in the reaction exhaust gas.

The electrochemical module M includes the plurality of the electrochemical elements E and the gas manifold 17. The plurality of the electrochemical elements E are disposed in parallel in a state of being electrically connected to each other, and each end (lower end) of the electrochemical elements E is fixed to the gas manifold 17. The electrochemical element E performs power generation by causing an electrochemical reaction between the reformed gas supplied through the gas manifold 17 and air supplied from the blower 35.

The inverter 38 adjusts output power of the electrochemical module M to electric power having the same voltage and the same frequency as those of electric power received from a commercial system (not illustrated). Therefore, the inverter 38 is an electric power converter that extracts electric power from the electrochemical element E or the electrochemical module M. The controller 39 controls operations of the electrochemical device Y and the energy system Z.

The vaporizer 33, the reformer 34, the electrochemical module M, and the combustion section 36 are housed in the storage container 40. The reformer 34 reforms a raw fuel by using combustion heat generated by the combustion of the reaction exhaust gas in the combustion section 36.

The raw fuel is supplied to the desulfurizer 31 through the raw fuel supply channel 42 by an operation of a booster pump 41. The reforming water in the reforming water tank 32 is supplied to the vaporizer 33 through a reforming water supply channel 44 by an operation of a reforming water pump 43. The raw fuel supply channel 42 is joined at a location of downstream of the desulfurizer 31 into the reforming water supply channel 44, and supplies the reforming water and the raw fuel, which are joined at a location outside the storage container 40 to the vaporizer 33 provided inside the storage container 40.

The reforming water is vaporized by the vaporizer 33 to be steam. The raw fuel containing steam generated by the vaporizer 33 is supplied to the reformer 34 through a steam-containing raw fuel supply channel 45. The raw fuel is steam-reformed in the reformer 34 to generate a reformed gas whose main component is a hydrogen gas (a fuel gas containing hydrogen, which is the reduction gas described so far). The reformed gas generated by the reformer 34 is supplied to the gas manifold 17 of the electrochemical module M through a reformed gas supply channel 46.

The reformed gas supplied to the gas manifold 17 is distributed to the plurality of the electrochemical elements E, and is supplied from a lower end of a connection portion between the electrochemical elements E and the gas manifold 17 to the electrochemical elements E. Mainly hydrogen in the reformed gas is used for an electrochemical reaction in the electrochemical elements E. Therefore, the reformer 34 is a fuel converter that supplies a gas containing the reduction gas to the electrochemical elements E or the electrochemical module M. The reaction exhaust gas containing a residual hydrogen gas that is not used in the reaction is discharged from upper ends of the electrochemical elements E to the combustion section 36.

The reaction exhaust gas is combusted in the combustion section 36 and becomes a combustion exhaust gas, and the combustion exhaust gas discharged to the outside of the storage container 40 from a combustion exhaust gas outlet 50. A combustion catalyst section 51 (for example, a platinum-based catalyst) is disposed at the combustion exhaust gas outlet 50 to combust and remove reduction gases such as carbon monoxide and hydrogen contained in the combustion exhaust gas. The combustion exhaust gas discharged from the combustion exhaust gas outlet 50 is transmitted to the heat exchanger 53 through a combustion exhaust gas discharge channel 52.

The heat exchanger 53 exchanges heat between the combustion exhaust gas generated by combustion in the combustion section 36 and cold water supplied to generate hot water. That is, the heat exchanger 53 operates as an exhaust heat utilization section for reusing the heat discharged from the electrochemical device Y.

In addition, instead of the exhaust heat utilization section, a reaction exhaust gas utilization section (not illustrated) may be provided for utilizing the reaction exhaust gas discharged (without combustion) from the electrochemical module M. The reaction exhaust gas contains a residual hydrogen gas that has not been used in the reaction in the electrochemical elements E. In the reaction exhaust gas utilization section, the residual hydrogen gas is used to utilize heat by combustion and power generation by a fuel cell or the like, so that energy can be effectively utilized.

### Another Embodiment of Electrochemical Module

FIG. 18 illustrates another embodiment of the electrochemical module M.

Regarding the electrochemical module M according to another embodiment, the electrochemical module M is configured to stack the above-mentioned electrochemical elements E with an intercell connection member 71 interposed therebetween.

The intercell connection member 71 is a plate-shaped member having conductivity and no gas permeability, and grooves 72 orthogonal to each other are formed on the front surface and the back surface. As the intercell connection member 71, a metal such as stainless steel or a metal oxide can be used.

As illustrated in FIG. 18, in a case where the electrochemical elements E are stacked with the intercell connection member 71 interposed therebetween, a gas can be supplied to the electrochemical elements E through the grooves 72. Specifically, the grooves 72 on one side are first gas flow channels 72a to supply a gas to the front side of each electrochemical element E, that is, the counter electrode layer 6. The grooves 72 on the other side are second gas flow channels 72b, and a gas is supplied to the electrode layer 2 from the back side of each electrochemical element E, that is, the back surface of the metal substrate 1 through the through-holes 1a.

In a case where the electrochemical module M is operated as a fuel cell, an oxidization gas (typically, air containing oxygen) is supplied to the first gas flow channels 72a, and a reduction gas (typically, a fuel gas containing hydrogen) is supplied to the second gas flow channels 72b. Then, a reaction in the electrochemical module M as a fuel cell proceeds in the electrochemical elements E, and electromotive force and current are generated. The generated electric power is extracted from the intercell connection members 71 on both ends of the stacked electrochemical elements E to the outside of the electrochemical module M.

In the present embodiment, the grooves 72 orthogonal to each other are formed on the front surface and the back surface of each intercell connection member 71, but the grooves 72 parallel to each other can also be formed on the front surface and the back surface of the intercell connection member 71.

### Another Embodiment

(1) In the above-mentioned embodiment, the electrochemical element E is used for the solid oxide fuel cell, but the electrochemical element E can also be used for a solid oxide electrolysis cell, an oxygen sensor obtained by using a solid oxide, or the like.

Hereinafter, an example of using the electrochemical element E as a solid oxide electrolysis cell will be described with reference to the drawings. As illustrated above, this example is an example in which the electrochemical device Y according to the present invention is a hydrocarbon production system 100, and the electrochemical element E is operated by supplying a predetermined raw gas and electric power to serve as an electrolytic reaction section 10. That is, as a result of supplying water H₂O and carbon dioxide CO₂ to the electrolytic reaction section 10, carbon monoxide CO and hydrogen H₂ as raw materials for synthesizing hydrocarbons are obtained by decomposing water H₂O and carbon dioxide CO₂. Then, a hydrocarbon can be obtained in a hydrocarbon synthesis reaction section 30.

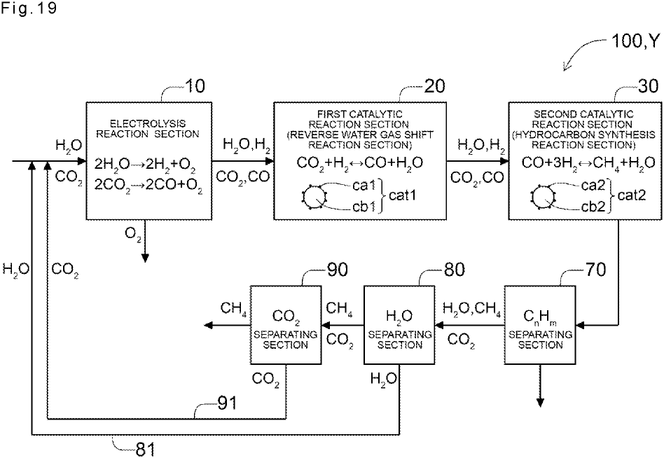

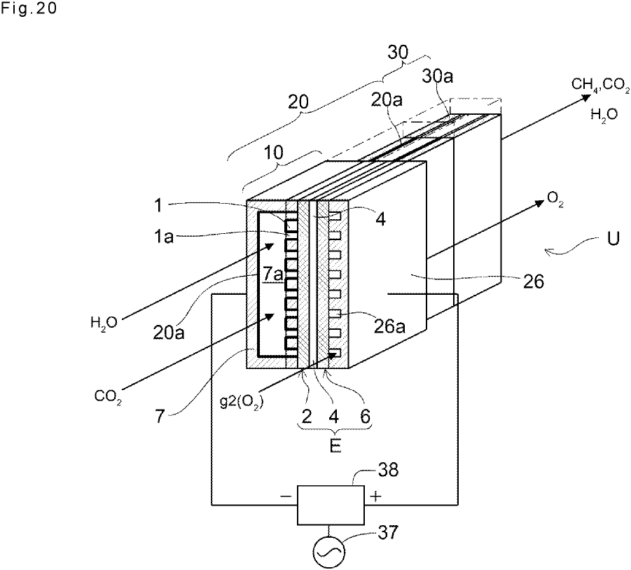

FIG. 19 is a system diagram illustrating the overall configuration of the hydrocarbon production system 100, and FIG. 20 illustrates a configuration example of an electrolytic cell unit U established as the hydrocarbon production system 100.

As can be seen from FIG. 19, the hydrocarbon production system 100 includes the electrolytic reaction section 10, a first catalytic reaction section 20, a second catalytic reaction section 30, a heavy hydrocarbon separating section 70 (illustrated as a CnHm separating section), a water separating section 80 (illustrated as a H₂O separating section), and a carbon dioxide separating section 90 (illustrated as a CO₂ separating section) in this order. In FIG. 19, the electrolytic reaction section 10, the first catalytic reaction section 20, and the second catalytic reaction section 30 are illustrated separately, but as illustrated in FIG. 20, these sections 10, 20, and 30 are provided to serve as the single electrolytic cell unit U.

The electrolytic reaction section 10 is a section that electrolyzes at least a part of a gas flowing thereinto, the first catalytic reaction section 20 is a reverse water gas shift reaction section in which at least a part of a gas flowing thereinto is subjected to a reverse water gas shift reaction, and the second catalytic reaction section 30 is a hydrocarbon synthesis reaction section that synthesizes at least a part of a gas flowing thereinto into a hydrocarbon. Here, the synthesized hydrocarbon is mainly CH₄ (hydrocarbon having one carbon atom), but may include lower saturated hydrocarbon having 2 to 4 carbon atoms and the like. Furthermore, a hydrocarbon having a larger number of carbon atoms than the lower saturated hydrocarbon and being in no saturated state is also synthesized. These heavy hydrocarbons can be collected and separated by the heavy hydrocarbon separating section 70 as a gas released from the second catalytic reaction section 30 cools.

The water separating section 80 and the carbon dioxide separating section 90 are sections in which at least some of predetermined components (H₂O and CO₂ in the order of description) are removed from the gas flowing inside. As illustrated in the figure, the components removed and recovered through these sections are returned to a predetermined section of the system through a water return channel 81 and a carbon dioxide return channel 91 and are reused. H₂O and CO₂ returned through the water return channel 81 and the carbon dioxide return channel 91 are illustrated on both return channels 81 and 91, respectively.

As a result, this hydrocarbon production system 100 is established as a carbon closed system that does not substantially release CO₂ to the outside of the system.

In the figure, a gas flowing into each section is illustrated at the front side of each section, and a gas released from the section is illustrated at the rear side.

H₂O and CO₂ as raw gases flow in the electrolytic reaction section 10 and are electrolyzed internally, H₂O is decomposed into H₂ and O₂, some CO₂ is decomposed into CO and O₂, which are released.

The reaction is described as follows.

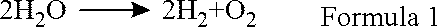

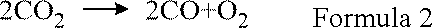

These Formulae 1 and 2 are also illustrated in the box illustrating the electrolytic reaction section 10 of FIG. 15.

At least H₂ and CO₂ flow in the first catalytic reaction section 20 (reverse water gas shift reaction section), a reverse water gas shift reaction occurs inside the first catalytic reaction section 20, CO₂ becomes CO, and H₂ becomes H₂O, which are released.

The reaction is described as the following equilibrium reaction, but the reverse water gas shift reaction is a reaction (CO₂ and H₂ react with each other to form CO and H₂O) in which a reaction described by the following Formula 3 proceeds to the right.

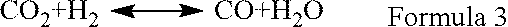

This Formula 3 is also illustrated in the box illustrating the first catalytic reaction section 20 (reverse water gas shift reaction section) in FIG. 15. A reverse water gas shift catalyst cat1 used in the reaction is also schematically illustrated in the box.

As this kind of the reverse water gas shift catalyst cat1, the inventors have considered that a catalyst obtained by supporting any one of nickel or iron or both nickel and iron on one or more carriers cb1 (metal oxide carriers) selected from ceria-based metal oxides, zirconia-based metal oxides, and alumina-based metal oxides is preferable as a catalyst activation component ca1 (metal catalyst).

At least H₂ and CO flow into the second catalytic reaction section 30 (hydrocarbon synthesis reaction section) to synthesize a hydrocarbon through a catalytic reaction.

For example, a reaction in which CH₄ is synthesized from CO and H₂ is described as the following equilibrium reaction, and the reaction in which CH₄ is synthesized from CO and H₂ is a reaction in which the reaction described by the following Formula 4 proceeds to the right (CO and H₂ react with each other to form CH₄ and H₂O).

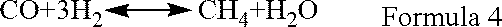

This Formula 4 is also illustrated in the box illustrating the second catalytic reaction section 30 (hydrocarbon synthesis reaction section) in FIG. 15. A hydrocarbon synthesis catalyst cat2 used in the reaction is also schematically illustrated in the box.

As this kind of the hydrocarbon synthesis catalyst cat2, the inventors have considered that a catalyst obtained by supporting at least ruthenium on a carrier cb2 (metal oxide carrier), for example, alumina or the like, is preferable as a catalyst activation component ca2.

Furthermore, the equilibrium reaction of (Formula 3) also occurs at this section.

A Fischer-Tropsch (FT) synthesis reaction can proceed depending on the kinds of the catalyst used in the second catalytic reaction section 30, so that hydrocarbons such as ethane and propane are synthesized from CO and H₂.

Generated H₂O is separated in the water separating section 80 and returned to the upstream of the electrolytic reaction section 10 through the water return channel 81 (water recycling line).

Generated CO₂ is separated in the carbon dioxide separating section 90 and returned to the upstream of the electrolytic reaction section 10 through the carbon dioxide return channel 91 (carbon dioxide recycling line).

As a result, in this hydrocarbon production system 100, the hydrocarbon is finally synthesized and can be supplied to the outside.

FIG. 20 illustrates the electrolytic cell unit U including the electrochemical element E in the electrolytic reaction section 10 and including the reverse water gas shift reaction section 20 and the hydrocarbon synthesis reaction section 30 which are provided side by side. FIG. 20 is a diagram illustrating the electrolytic cell unit U, including an advection direction of the gas.

In this figure, in order to clarify the electrochemical reaction system, the interlayer 3 and the reaction preventing layer 5 of the electrochemical element E in FIG. 15 are not provided. Furthermore, in comparison with FIG. 19, the heavy hydrocarbon separating section 70, the water separating section 80, and the carbon dioxide separating section 90 are not provided.

This electrolytic cell unit U is also configured to include the electrochemical element E in which the electrode layer 2 and the counter electrode layer 6 are formed with the electrolyte layer 4 interposed therebetween, the metal substrate 1 as a metal support that serves as a separator, the U-shaped member 7 that serves as a supply channel forming member, and the current-collecting member 26 that serves as a supply channel forming member, and adopts a configuration in which an electrode layer-side gas supply channel 7a and a counter electrode layer-side gas supply channel 26a are formed. H₂O and CO₂ to be electrolyzed are supplied to the electrode layer-side gas supply channel 7a. On the other hand, an air g2 (O₂) that is an example of an oxygen-containing gas is supplied to the counter electrode layer-side gas supply channel 26a. The electrochemical module M can be constructed by stacking (assembling) the electrolytic cell units U in the left-right direction of FIG. 20 in a thickness direction of the unit.

As described above, the electrolyte layer 4 and the electrode layer 2 as a part thereof can be constructed by using the coating composition b2 according to the present invention.

This configuration of another implementation is an example in which the electrochemical element E is operated as the electrolytic reaction section 10, but as can be seen from FIG. 20, direct current power is supplied between the electrode layer 2 and the counter electrode layer 6. In the illustrated example, an example in which the electric power obtained from an alternating-current power 37 is AC/DC converted by the inverter 38 and supplied to the electrochemical element E is illustrated. Therefore, in a case where the inverter 38 is the electrochemical element E or an assembly of the electrochemical elements E, the inverter 38 is an electric power converter that supplies electric power to the electrochemical module M that is the assembly.

However, the reverse water gas shift catalyst cat1 is applied on an inner surface of the electrode layer-side gas supply channel 7a (an inner surface of the U-shaped member 7 on the supply channel side, a surface of the metal substrate 1 opposite to a surface on which the electrode layer 2 is formed, and surfaces of a plurality of through-holes 1a). This coating layer 20b is illustrated by a thick solid line.

Furthermore, the electrode layer-side gas supply channel 7a extends over the electrolytic reaction section 10, and the coating layer 20b is also provided on the extension side. Furthermore, a hydrocarbon synthesis catalyst cat 2 is applied to the tip thereof, and a coating layer 30b is provided to form the hydrocarbon synthesis reaction section 30.

As a result, in this configuration, in a case where the hydrocarbon synthesis reaction section 30 is the electrochemical element E or an assembly of the electrochemical elements E, the hydrocarbon synthesis reaction section 30 is an electric power converter that supplies electric power to the electrochemical module M that is the assembly.

A hydrocarbon can be obtained in the hydrocarbon synthesis reaction section 30 by using a gas obtained in the electrolytic reaction section 10 and the reverse water gas shift reaction section 20.

(2) In the above embodiment, the metal-supported solid oxide fuel cell having a metal substrate 1 as a support is used, but in the present invention, an electrode-supported solid oxide fuel cell having the electrode layer 2 or the counter electrode layer 6 as a support, or an electrolyte-supported solid oxide fuel cell having the electrolyte layer 4 as a support can be used. In these cases, the electrode layer 2, the counter electrode layer 6, or the electrolyte layer 4 can be made to have a required thickness, so that the function as a support can be obtained.

(3) In the above embodiment, as a material of the electrode layer 2, for example, a composite material such as NiO—GDC, Ni—GDC, NiO—YSZ, Ni—YSZ, CuO—CeO₂, or Cu—CeO₂ was used, and as a material of the counter electrode layer 6, for example, a composite oxide such as LSCF or LSM was used. The electrochemical element E configured in this way can be used as a solid oxide fuel cell by supplying hydrogen gas to the electrode layer 2 to serve as a fuel electrode and supplying air to the counter electrode layer 6 to serve as an air electrode. It is also possible to modify this configuration to configure the electrochemical element E so that the electrode layer 2 can serve as an air electrode and the counter electrode layer 6 can serve as a fuel electrode. That is, a composite oxide such as LSCF or LSM is used as a material of the electrode layer 2, and for example, a composite material such as NiO—GDC, Ni—GDC, NiO—YSZ, Ni—YSZ, CuO—CeO₂, or Cu—CeO₂ is used as a material of the counter electrode layer 6. In the electrochemical element E configured as described above, air can be supplied to the electrode layer 2 to serve as an air electrode, a hydrogen gas can be supplied to the counter electrode layer 6 to serve as a fuel electrode, and the electrochemical element E can be a solid oxide fuel cell.

(4) In the above embodiment, an example in which the composite oxide film containing Co is formed on the surface of the Fe—Cr alloy as the metal substrate 1 to prevent volatilization of Cr and the like from this material, but one or more of the U-shaped member 7 as a separator, the gas manifold 17, the current-collecting member 26, and the intercell connection member 71 as an interconnector may be made of this type of alloy member.

On the other hand, as this type of oxide film, an oxide film containing only Co may be formed on the surface of the Fe—Cr alloy. It is effective to the volatilization of Cr.

The configurations disclosed in the above embodiments can be applied in combination with the configurations disclosed in other embodiments as long as there is no contradiction. The embodiments disclosed in the present specification are examples, and the embodiments of the present invention are not limited thereto, and can be appropriately modified without departing from the objective of the present invention.

### REFERENCE SIGNS LIST

1: Metal substrate (metal support)
1a: Through-hole
2: Electrode layer
3: Interlayer
4: Electrolyte layer
5: Reaction preventing layer
6: Counter electrode layer
7: U-shaped member (separator)
10: Electrolytic reaction section
17: Gas manifold (manifold)
20: First catalytic reaction section (reverse water gas shift reaction section)
26: Current-collecting member
30: Second catalytic reaction section (hydrocarbon synthesis reaction section/fuel converter)
31: Desulfurizer
32: Reforming water tank
33: Vaporizer
34: Reformer (fuel converter)
35: Blower
36: Combustion section
38: Inverter (electric power converter)
39: Controller
40: Storage container
41: Booster pump
42: Raw fuel supply channel
43: Reforming water pump
44: Reforming water supply channel
45: Steam-containing raw fuel supply channel
46: Reformed gas supply channel
50: Combustion exhaust gas outlet
51: Combustion catalyst section
52: Combustion exhaust gas discharge channel
53: Heat exchanger (exhaust heat utilization section)
70: Heavy hydrocarbon separating section
71: Intercell connection member (interconnector)
72: Groove
72a: First gas flow channel
72b: Second gas flow channel
80: Water separating section
90: Carbon dioxide separating section
100: Hydrocarbon production system E: Electrochemical element
M: Electrochemical module
Pa: Yttria-stabilized zirconia fine particles
U: Electrolytic cell unit
Y: Electrochemical device
Z: Energy system
o: Zirconium alkoxide
p: Yttrium compound
q: Chelate compound
r: Catalyst
s: Water
t: Organic solvent

1. A method for producing a coating composition comprising:
mixing a composition containing a zirconium alkoxide, an yttrium compound, a chelate compound, a catalyst, water, and an organic solvent to produce a coating composition.

2. The method for producing a coating composition according to claim 1, wherein the coating composition contains yttria-stabilized zirconia fine particles.

3. The method for producing a coating composition according to claim 2, wherein a content of the yttria-stabilized zirconia fine particles is 1% to 10% by mass with respect to the zirconium alkoxide.

4. The method for producing a coating composition according to claim 2, wherein an average particle size of the yttria-stabilized zirconia fine particles is 0.1 to 2 µm.

5. The method for producing a coating composition according to claim 1, wherein in the coating composition, a content of the zirconium alkoxide is 10% to 30% by mass, a content of the yttrium compound is 1% to 10% by mass, a content of the chelate compound is 5% to 20% by mass, a content of the catalyst is 0.1% to 2% by mass, a content of the water is 0.1% to 2% by mass, and a content of the organic solvent is a remainder.

6. The method for producing a coating composition according to claim 1, wherein the zirconium alkoxide is any one or more of zirconium (IV) methoxide, zirconium (IV) ethoxide, zirconium (IV) n-propoxide, zirconium (IV) i-propoxide, zirconium (IV) n-butoxide, zirconium (IV) i-butoxide, zirconium (IV) sec-butoxide, or zirconium (IV) t-butoxide.

7. The method for producing the coating composition according to claim 1, wherein the yttrium compound is any one or more of yttrium nitrate, yttrium chloride, yttrium sulfate, yttrium phosphate, yttrium acetate, yttrium carbonate, yttrium (III) ethoxide, yttrium (III) n-propoxide, or yttrium (III) i-propoxide.

8. The method for producing the coating composition according to claim 1, wherein the chelate compound is General Formula (1), 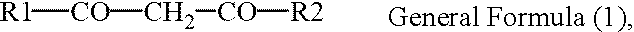
wherein, in General Formula (1), R1 and R2 are alkyl groups having 1 to 6 carbon atoms, including a fluorinated alkyl group, or monocyclic or bicyclic aryl groups; R1 and R2 are the same or different from each other, and each are an alkyl group having 1 to 6 carbon atoms or a monocyclic or bicyclic aryl group, and R1 and R2 may be bonded to each other to form a cyclic alkyl group.

9. The method for producing the coating composition according to claim 1, wherein the chelate compound is any one or more of 2,4-pentanedione, 2,4-hexanedione, 3,5-heptanedione, 2,6-dimethyl-3,5-heptanedione, 2,2,6,6-tetramethyl-3,5-heptanedione, 1-phenyl-1,3-butanedione, 1,3-diphenyl-1,3-propanedione, 1,1,1-trifluoro-2,4-pentanedione, 1,1,1,5,5,5-hexafluoro-2,4-pentanedione, or 1,3-cyclohexanedione.

10. The method for producing the coating composition according to claim 1, wherein the catalyst is any one or more of hydrochloric acid, nitric acid, sulfuric acid, phosphoric acid, carbonic acid, or acetic acid.

11. The method for producing the coating composition according to claim 1, wherein the organic solvent is any one or more of methanol, ethanol, 1-propanol, 2-propanol, 1-butanol, 2-methyl-1-propanol, 2-butanol, or 2-methyl-2-propanol.

12. The method for producing the coating composition according to claim 1, wherein the organic solvent is an alcohol having a smaller number of carbon atoms than an alcohol corresponding to an alkoxide of the zirconium alkoxide.

13. An yttria-stabilized zirconia layer obtained by curing the coating composition that is produced by the method for producing the coating composition according to claim 1.

14. An electrochemical element comprising the yttria-stabilized zirconia layer according to claim 13.

15. The electrochemical element according to claim 14, wherein the electrochemical element includes a metal support.

16. An electrochemical module comprising a plurality of the electrochemical elements according to claim 14, which are disposed in a state of being assembled.

17. An electrochemical device comprising:
at least one electrochemical element according to claim 14 ; and
a fuel converter that supplies a gas containing a reduction gas to the at least one electrochemical element, or a fuel converter for converting a gas containing a reduction gas generated from the at least one electrochemical element .

18. An electrochemical device comprising:
at least one electrochemical element according to claim 14 ; and
an electric power converter that extracts electric power from the at least one electrochemical element, or an electric power converter that supplies electric power to the at least one electrochemical element.

19. An energy system comprising:
the electrochemical device according to claim 17; and
an exhaust heat utilization section that reuses heat discharged from the electrochemical device.

20. A solid oxide fuel cell comprising the electrochemical element according to claim 14,
wherein the solid oxide fuel cell causes a power generation reaction in the electrochemical element.

21. A solid oxide electrolysis cell comprising the electrochemical element according to claim 14,
wherein the solid oxide electrolysis cell causes an electrolytic reaction in the electrochemical element.
